(19) United States
(12) Patent Application Publication
(10) Pub. No.: US 2013/0050225 A1
(43) Pub. Date: Feb. 28, 2013

(54) CONTROL POINT SETTING METHOD, CONTROL POINT SETTING APPARATUS AND RECORDING MEDIUM

(71) Applicant: Mitsuyasu NAKAJIMA, Tokyo (JP)

(72) Inventor: Mitsuyasu NAKAJIMA, Tokyo (JP)

(73) Assignee: CASIO COMPUTER CO., LTD., Tokyo (JP)

(21) Appl. No.: 13/592,094

(22) Filed: Aug. 22, 2012

(30) Foreign Application Priority Data
Aug. 25, 2011 (JP) 2011-183547

(51) Int. Cl. G06T 13/00

(52) U.S. Cl. 345/473

(57) ABSTRACT

A control point setting method, that uses a control point setting apparatus including a storage unit that stores motion information of a plurality of motion reference points set in a region of a moving subject model included in a reference image, includes: specifying positional information related to respective positions of the plurality of motion reference points in the region of the moving subject model based on model skeleton information related to a skeleton of the moving subject model; obtaining a subject image including a subject region; and setting a plurality of motion control points related to motion control for the subject region at respective positions individually corresponding to the plurality of motion reference points in the subject region based on subject skeleton information related to the skeleton of the subject of the subject image obtained in the obtaining and on the positional information specified in the specifying.

### CROSS-REFERENCE TO RELATED APPLICATIONS

This application is based upon and claims the benefit of priority from the prior Japanese Patent Application No. 2011-183547, filed on Aug. 25, 2011, the entire contents of which are incorporated herein by reference.

### BACKGROUND OF THE INVENTION

1. Field of the Invention

The present invention relates to a control point setting method, a control point setting apparatus and a recording medium.

2. Description of Related Art

Heretofore, there has been known a technology for moving a two-dimensional still image by setting motion control points at desired positions of the still image concerned, and by designating desired motions to the motion control points to which motions are desired to be imparted (U.S. Pat. No. 8,063,917).

However, in the case of the foregoing patent literature, the motion must be designated for each of the motion control points, and there are problems that not only an operation for such designation is troublesome but also the motion desired by the user cannot be played unless the setting of the motion control points is performed appropriately.

### SUMMARY OF THE INVENTION

It is an object of the present invention to provide a control point setting method, a control point setting apparatus and a recording medium, which are capable of performing the setting of the motion control points simply and appropriately.

According to an aspect of the present invention, there is provided a control point setting method that uses a control point setting apparatus including a storage unit that stores motion information of a plurality of motion reference points set in a region of a moving subject model included in a reference image, the control point setting method including:

specifying positional information related to respective positions of the plurality of motion reference points in the region of the moving subject model based on model skeleton information related to a skeleton of the moving subject model;

obtaining a subject image including a subject region; and

setting a plurality of motion control points related to motion control for the subject region at respective positions individually corresponding to the plurality of motion reference points in the subject region based on subject skeleton information related to the skeleton of the subject of the subject image obtained in the obtaining and on the positional information specified in the specifying.

According to another aspect of the present invention, there is provided a control point setting apparatus including a storage unit that stores motion information of a plurality of motion reference points set in a region of a moving subject model included in a reference image, the control point setting apparatus including:

a specifying unit which specifies positional information related to respective positions of the plurality of motion reference points in the region of the moving subject model based on model skeleton information related to a skeleton of the moving subject model;

an obtaining unit which obtains a subject image including a subject region; and

a control point setting unit which sets a plurality of motion control points related to motion control for the subject region at respective positions individually corresponding to the plurality of motion reference points in the subject region based on subject skeleton information related to the skeleton of the subject of the subject image obtained in the obtaining unit and on the positional information specified in the specifying unit.

According to still another aspect of the present invention, there is provided a recording medium recording a program which makes a computer of a control point setting apparatus including a storage unit that stores motion information of a plurality of motion reference points set in a region of a moving subject model included in a reference image, realize functions of:

a specifying function of specifying positional information related to respective positions of the plurality of motion reference points in the region of the moving subject model based on model skeleton information related to a skeleton of the moving subject model;

an obtaining function of obtaining a subject image including a subject region; and

a control point setting function of setting a plurality of motion control points related to motion control for the subject region at respective positions individually corresponding to the plurality of motion reference points in the subject region based on subject skeleton information related to the skeleton of the subject of the subject image obtained in the obtaining function and on the positional information specified in the specifying function.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 is a block diagram showing a schematic configuration of an animation creation system of an embodiment to which the present invention is applied;

FIG. 2 is a block diagram showing a schematic configuration of a user terminal that composes the animation creation system of FIG. 1;

FIG. 3 is a block diagram showing a schematic configuration of a server that composes the animation creation system of FIG. 1;

FIG. 4 is a flowchart showing an example of operations related to animation creation processing by the animation creation system of FIG. 1;

FIG. 5 is a flowchart showing a follow-up of the animation creation processing of FIG. 4;

FIG. 6 is a flowchart showing an example of operations related to control point setting processing in the animation creation processing of FIG. 5;

FIG. 7 is a flowchart showing an example of operations related to reference image analysis processing in the control point setting processing of FIG. 6;

FIG. 8A is a view schematically showing an example of an image related to the reference image analysis processing of FIG. 7;

FIG. 8B is a view schematically showing an example of the image related to the reference image analysis processing of FIG. 7;

FIG. 9A is a view schematically showing an example of the image related to the reference image analysis processing of FIG. 7;

FIG. 9B is a view schematically showing an example of the image related to the reference image analysis processing of FIG. 7;

FIG. 9C is a view schematically showing an example of the image related to the reference image analysis processing of FIG. 7;

FIG. 10A is a view schematically showing an example of an image related to subject image analysis processing in the control point setting processing of FIG. 6;

FIG. 10B is a view schematically showing an example of the image related to the subject image analysis processing in the control point setting processing of FIG. 6;

FIG. 11 is a flowchart showing an example of operations related to reference point specification processing in the control point setting processing of FIG. 6;

FIG. 12 is a view for explaining the reference point specification processing of FIG. 11;

FIG. 13 is a flowchart showing an example of operations related to control point position specification processing in the control point setting processing of FIG. 6; and

FIG. 14 is a view schematically showing an example of an image related to the control point position specification processing of FIG. 13.

### DETAILED DESCRIPTION OF THE PREFERRED EMBODIMENT

A description is made below of a specific aspect of the present invention by using the drawings. However, the scope of the invention is not limited to the illustrated example.

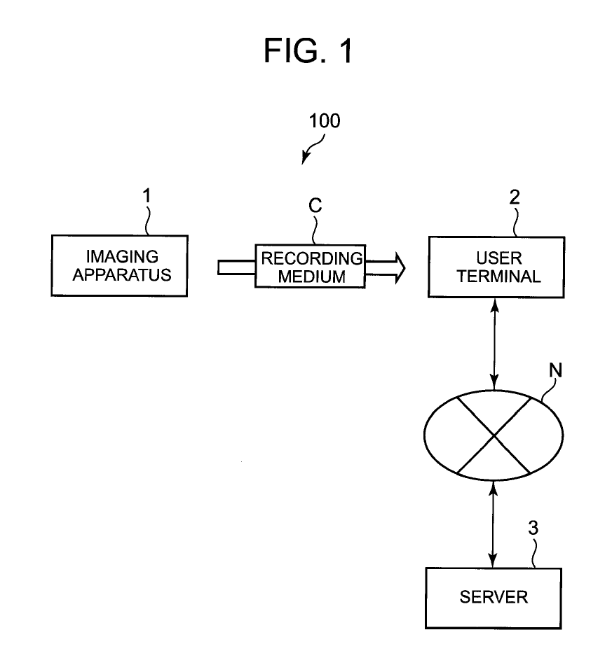

FIG. 1 is a block diagram showing a schematic configuration of an animation creation system 100 of an embodiment to which the present invention is applied.

As shown in FIG. 1, the animation creation system 100 of this embodiment includes: an imaging apparatus 1; a user terminal 2; and a server 3, in which the user terminal 2 and the server 3 are connected to each other through a predetermined communication network N so as to be capable of transferring a variety of information therebetween.

First, a description is made of the imaging apparatus 1.

The imaging apparatus 1 is provided with an imaging function to image a subject, a recording function to record image data of an imaged image in a recording medium C, and the like. That is to say, a device known in public is applicable as the imaging apparatus 1, and for example, the imaging apparatus 1 includes not only a digital camera that has the imaging function as a main function, but also a portable terminal such as a cellular phone provided with the imaging function though the imaging function is not regarded as a main function therein.

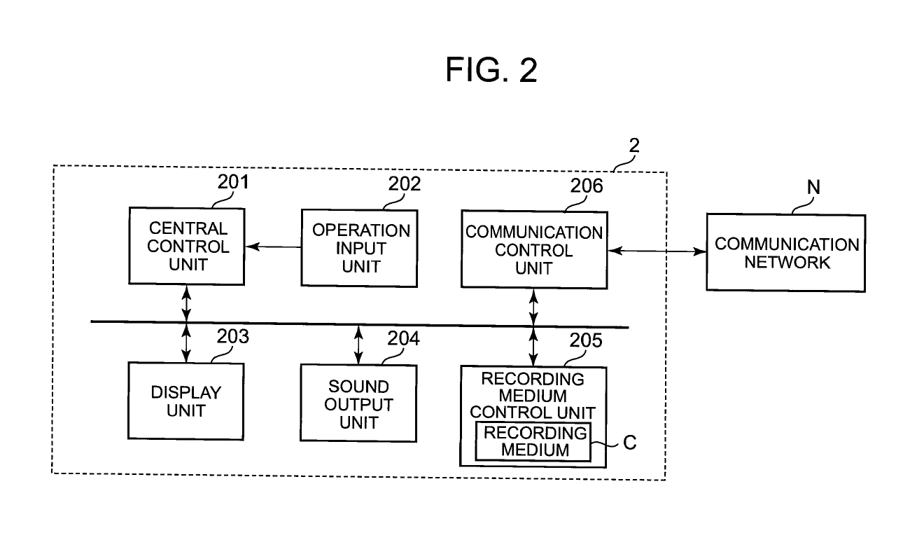

Next, a description is made of the user terminal 2 with reference to FIG. 2.

For example, the user terminal 2 is composed of a personal computer or the like, accesses a Web page (for example, an animation creating page) established by the server 3, and inputs a variety of instructions on the Web page.

FIG. 2 is a block diagram showing a schematic configuration of the user terminal.

As shown in FIG. 2, specifically, the user terminal 2 includes: a central control unit 201; an operation input unit 202; a display unit 203; a sound output unit 204; a recording medium control unit 205; a communication control unit 206; and the like.

The central control unit 201 controls the respective units of the user terminal 2. Specifically, the central control unit 201 includes a CPU, a RAM, and a ROM (any thereof is not shown), and performs a variety of control operations in accordance with a variety of processing programs (not shown) for the user terminal 2, which are stored in the ROM. In this event, the CPU allows a storage region in the RAM to store results of a variety of processing, and allows the display unit 203 to display such processing results according to needs.

For example, the RAM includes: a program storage region for expanding a processing program to be executed by the CPU, and the like; a data storage region for storing input data, processing results generated in the event where the processing program is executed, and the like; and the like.

The ROM stores: programs stored in a mode of a computer-readable program code, specifically, a system program executable by the user terminal 2, a variety of processing programs executable by the system program concerned; data for use in the event of executing these various processing programs; and the like.

For example, the operation input unit 202 includes: a keyboard composed of data input keys for inputting numeric values, letters and the like; cursor keys for performing selection and feeding operations of data, and the like; a variety of function keys; a mouse; and the like. The operation input unit 202 outputs a depression signal of a key depressed by a user and an operation signal of the mouse to the CPU of the central control unit 201.

Note that such a configuration may also be adopted, which arranges a touch panel (not shown) as the operation input unit 202 on a display screen of the display unit 203, and inputs a variety of instructions in response to contact positions of the touch panel.

For example, the display unit 203 is composed of a display such as an LCD and a cathode ray tube (CRT), and displays a variety of information on the display screen under control of the CPU of the central control unit 201.

That is to say, for example, based on page data of the Web page (for example, the animation creating page) transmitted from the server 3 and received by the communication control unit 206, the display unit 203 displays a Web page, which corresponds thereto, on the display screen. Specifically, based on image data of a variety of processing screens related to animation creation processing (described later), the display unit 203 displays a variety of processing screens on the display screen.

For example, the sound output unit 204 is composed of a D/A converter, a low pass filter (LPF), an amplifier, a speaker and the like, and emits a sound under the control of the CPU of the central control unit 201.

That is to say, for example, based on musical performance information transmitted from the server 3 and received by the communication control unit 206, the sound output unit 204 converts digital data of the musical performance information into analog data by the D/A converter, and emits a music at predetermined tone, pitch and duration from the speaker through the amplifier. Moreover, the sound output unit 204 may emit a sound of one sound source (for example, a musical instrument), or may emit sounds of a plurality of sound sources simultaneously.

The recording medium control unit 205 is composed so that the recording medium C can be freely attachable/detachable thereto/therefrom, and controls readout of data from the recording medium C attached thereonto and controls write of data to the recording medium C. That is to say, the recording medium control unit 205 reads out image data (YUV data) of a subject existing image (not shown), which is related to the animation creation processing (described later), from the recording medium C detached from the imaging apparatus 1 and attached onto the recording medium control unit 205, and then outputs the image data to the communication control unit 206.

Here, the subject existing image refers to an image in which a main subject exists on a predetermined background. Moreover, in the recording medium C, there is recorded image data of the subject existing image, which is encoded by an image processing unit (not shown) of the imaging apparatus 1 in accordance with a predetermined encoding format (for example, a JPEG format and the like).

Then, the communication control unit 206 transmits the image data of the subject existing image, which is inputted thereto, to the server 3 through the predetermined communication network N.

For example, the communication control unit 206 is composed of a modulator/demodulator (MODEM), a terminal adapter, and the like. The communication control unit 206 is a unit for performing communication control for information with an external instrument such as the server 3 through the predetermined communication network N.

Note that, for example, the communication network N is a communication network constructed by using a dedicated line or an existing general public line, and it is possible to apply a variety of line forms such as a local area network (LAN) and a wide area network (WAN). Moreover, for example, the communication network N includes: a variety of communication networks such as a telephone network, an ISDN network, a dedicated line, a mobile network, a communication satellite line, and a CATV network; an internet service provider that connects these to one another; and the like.

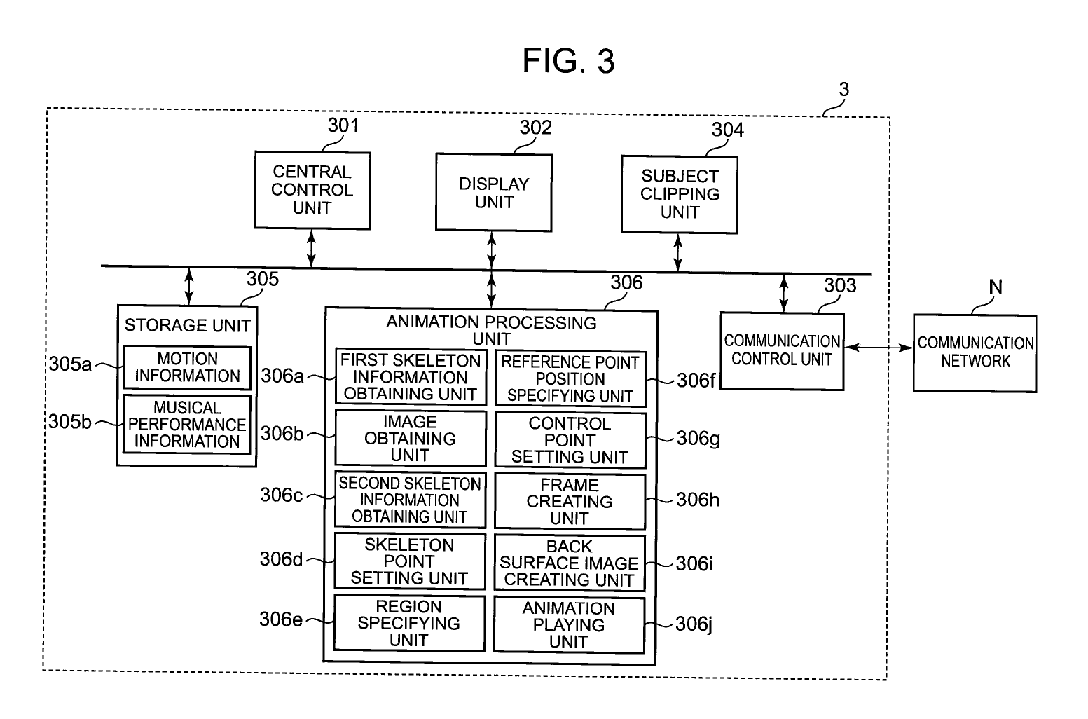

Next, a description is made of the server 3 with reference to FIG. 3.

The server 3 is a Web (World Wide Web) server that is provided with a function to establish the Web page (for example, the animation creating page) on the Internet. The server 3 transmits the page data of the Web page to the user terminal 2 in response to an access from the user terminal 2 concerned. Moreover, based on model skeleton information related to a skeleton of a moving subject model of a reference image P1, the server 3 as a control point setting apparatus specifies positional information related to the respective positions of a plurality of motion reference points Q . . . in a model region 1A of the reference image P1, which includes the moving subject model of the reference image P1, and further, obtains subject skeleton information related to a skeleton of the subject of a subject image. Then, based on the subject skeleton information related to the skeleton of the subject of the subject image and on the positional information related to the respective positions of the plurality of motion reference points Q . . . in the model region 1A, the server 3 sets a plurality of motion control points J, which are related to control for motions of the subject region, at the respective positions individually corresponding to the plurality of motion reference points Q . . . in the subject region.

FIG. 3 is a block diagram showing a schematic configuration of the server 3.

As shown in FIG. 3, specifically, the server 3 is composed by including: a central control unit 301; a display unit 302; a communication control unit 303; a subject clipping unit 304; a storage unit 305; an animation processing unit 306; and the like.

The central control unit 301 controls the respective units of the server 3. Specifically, the central control unit 301 includes a CPU, a RAM, and a ROM (any thereof is not shown), and performs a variety of control operations in accordance with a variety of processing programs (not shown) for the server 3, which are stored in the ROM. In this event, the CPU allows a storage region in the RAM to store results of a variety of processing, and allows the display unit 302 to display such processing results according to needs.

For example, the RAM includes: a program storage region for expanding a processing program to be executed by the CPU, and the like; a data storage region for storing input data, processing results generated in the event where the processing program is executed, and the like; and the like.

The ROM stores: programs stored in a mode of a computer-readable program code, specifically, a system program executable by the server 3, a variety of processing programs executable by the system program concerned; data for use in the event of executing these various processing programs; and the like.

For example, the display unit 302 is composed of a display such as an LCD and a CRT, and displays a variety of information on a display screen under control of the CPU of the central control unit 301.

For example, the communication control unit 303 is composed of a MODEM, a terminal adapter, and the like. The communication control unit 303 is a unit for performing communication control for information with an external instrument such as the user terminal 2 through the predetermined communication network N.

Specifically, for example, the communication control unit 303 receives the image data of the subject existing image (not shown), which is transmitted from the user terminal 2 through the predetermined communication network N in the animation creation processing (described later), and outputs the image data concerned to the CPU of the central control unit 301.

The CPU of the central control unit 301 outputs the image data of the subject existing image, which is thus inputted, to the subject clipping unit 304.

The subject clipping unit 304 creates a subject clipped image (not shown) from the subject existing image.

That is to say, by using a subject clipping method known in public, the subject clipping unit 304 creates a subject clipped image in which the subject region including the subject is clipped from the subject existing image. Specifically, the subject clipping unit 304 obtains the image data of the subject existing image, which is outputted from the CPU of the central control unit 301, and partitions the subject existing image, which is displayed on the display unit 203, by boundary lines (not shown) drawn on the subject existing image concerned, for example, based on a predetermined operation for the operation input unit 202 (for example, the mouse and the like) of the user terminal 2 by the user. Subsequently, the subject clipping unit 304 estimates a background of the subject in a plurality of partition regions obtained by the partitioning by such clipping lines of the subject existing image, performs a predetermined arithmetic operation based on pixel values of the respective pixels of the background, and estimates that a background color of the subject is a predetermined single color. Thereafter, between such a background image with the predetermined single color and the subject existing image, the subject clipping unit 304 creates difference information (for example, a difference degree map and the like) of the respective pixels corresponding thereto. Then, the subject clipping unit 304 compares pixel values of the respective pixels in the created difference information with a predetermined threshold value, then binarizes the pixel values, and thereafter, performs labeling processing for assigning the same numbers to pixel aggregates which compose the same connected components, and defines a pixel aggregate with a maximum area as a subject portion.

Thereafter, for example, the subject clipping unit 304 implements a low pass filter for the binarized difference information, in which the foregoing pixel aggregate with the maximum area is “1”, and other portions are “0”, generates an intermediate value on a boundary portion, and thereby creates an alpha value. Then, the subject clipping unit 304 creates an alpha map (not shown) as positional information indicating a position of the subject region in the subject clipped image.

For example, the alpha value (0≦α≦1) is a value that represents weight in the event of performing alpha blending for the image of the subject region with the predetermined background for each pixel of the subject existing image. In this case, an alpha value of the subject region becomes “1”, and a transmittance of the subject existing image with respect to the predetermined background becomes 0%. Meanwhile, an alpha value of such a background portion of the subject becomes “0”, and a transmittance of the subject existing image with respect to the predetermined background becomes 100%.

Then, based on the alpha map, the subject clipping unit 304 synthesizes the subject image with the predetermined single color image and creates image data of the subject clipped image so that, among the respective pixels of the subject existing image, the pixels with the alpha value of “1” cannot be transmitted through the predetermined single color image, and the pixels with the alpha value of “0” can be transmitted therethrough.

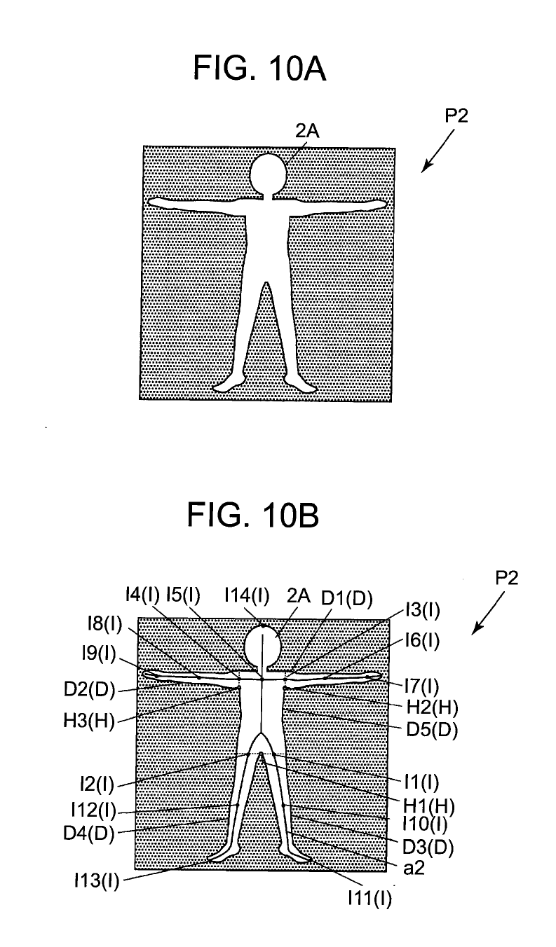

Moreover, based on the alpha map, the subject clipping unit 304 creates a mask image P2 (refer to FIG. 10A) as a binary image, in which a pixel value of the respective pixels of a subject region 2A (region shown white in FIG. 10A) is set at a first pixel value (for example, “1” and the like), and a pixel value of the respective pixels of such a background region (region dotted in FIG. 10A) is set at a second pixel value (for example, “0” and the like) different from the first pixel value. That is to say, the subject clipping unit 304 creates the mask image P2 as the positional information indicating the position of the subject region 2A in the subject clipped image.

For example, the image data of the subject clipped image is data associated with the created positional information such as the alpha map and the mask image P2.

Note that the above-described subject clipping method by the subject clipping unit 304 is merely an example, a subject clipping method of the present invention is not limited to this, and any method may be applied as long as the method concerned is a publicly known method of clipping the subject region, which includes the subject, from the subject existing image.

Moreover, for example, as the image data of the subject clipped image, image data of an RGBA format may be applied, and specifically, information of the transmittance (A) is added to the respective colors defined in an RGB color space. In this case, by using the information of the transmittance (A), the subject clipping unit 304 may create the positional information (not shown) indicating the position of the subject region in the subject clipped image.

For example, the storage unit 305 is composed of a nonvolatile semiconductor memory, a hard disc drive (HDD) or the like, and stores the page data of the Web page, which is to be transmitted to the user terminal 2, the image data of the subject clipped image, which is created by the subject clipping unit 304, and the like.

Moreover, the storage unit 305 stores plural pieces of motion information 305a for use in the animation creation processing.

Each piece of the motion information 305a is information associated with the reference image P1 of the moving subject model and indicating motions of the plurality of motion reference points Q . . . in a predetermined space, that is, for example, a two-dimensional flat space defined by two axes (for example, an x-axis, a y-axis and the like) perpendicular to each other, and in a three-dimensional stereoscopic space defined by an axis (for example, a z-axis or the like) perpendicular to these two axes in addition thereto. Note that each piece of the motion information 305a may also be such information that imparts a depth to the motions of the plurality of motion reference points Q . . . by rotating the two-dimensional flat space about a predetermined rotation axis.

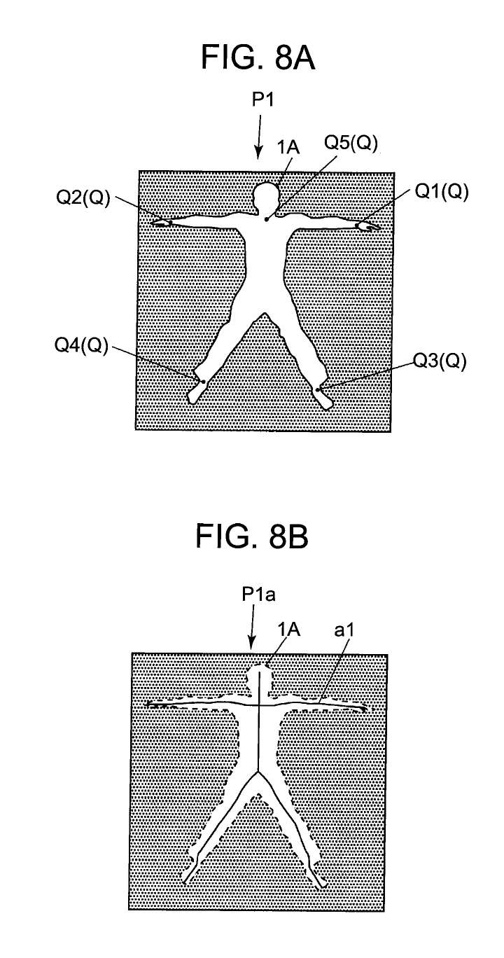

The reference image P1 is information indicating a position of the model region 1A of the moving subject model, and for example, is a binary image, in which a pixel value of the respective pixels of the model region 1A (region shown white in FIG. 8A) is set at a first pixel value (for example, “1” and the like), and a pixel value of the respective pixels of other region (region dotted in FIG. 8A) is set at a second pixel value (for example, “0” and the like) different from the first pixel value.

The positions of the respective motion reference points Q are individually defined in consideration of a skeleton shape, joint positions and the like of the moving subject model (for example, a person, an animal or the like) which becomes a model of the motions. That is to say, the respective motion reference points Q are set in the model region A, which includes the moving subject model of the reference image P1 showing a state where the person as the moving subject model is viewed from a predetermined direction (for example, the front), in consideration of the skeleton shape, joint positions and the like of the moving subject model.

Specifically, for example, in the model region 1A of the reference image P1, which simulates an outer shape of the person, motion reference points Q1 and Q2 of left and right wrists are set at positions respectively corresponding to left and right wrists of the person, moreover, motion reference points Q3 and Q4 of left and right ankles are set at positions respectively corresponding to left and right ankles of the person, and furthermore, a motion reference point Q5 of a neck is set at a position corresponding to a neck of the person (refer to FIG. 8A).

Here, FIG. 8A shows the reference image P1 schematically showing the state where the person as the moving subject model is viewed from the front. In the reference image P1 concerned, on a left side when viewed from the front, a right arm and right leg of the person as the moving subject model is arranged, and meanwhile, on a right side thereof when viewed from the front, a left arm and left leg of the person as the moving subject model is arranged.

Moreover, in each piece of the motion information 305a, plural pieces of coordinate information, in each of which all or at least one of the plurality of motion reference points Q . . . is moved in a predetermined space, are continuously arrayed at a predetermined time interval, whereby the motions of the plurality of motion reference points Q . . . are continuously shown. Specifically, each piece of the motion information 305a is, for example, information in which the plurality of motion reference points Q . . . set in the model region 1A of the reference image P1 are moved so as to correspond to a predetermined dance.

Note that each piece of the coordinate information of the plurality of motion reference points Q . . . may be, for example, information in which movements of the respective motion reference points Q with respect to coordinate information of the motion reference point Q to serve as a reference are defined, or may be information in which absolute position coordinates of the respective motion reference points Q are defined. Moreover, the number of motion reference points Q is settable appropriately and arbitrarily in response to a shape, size and the like of the moving subject model.

Moreover, the storage unit 305 stores plural pieces of musical performance information 305b for use in the animation creation processing.

The plural pieces of musical performance information 305b are information for automatically performing the music together with the animation by an animation playing unit 306j (described later) of the animation processing unit 306. That is to say, for example, the plural pieces of musical performance information 305b are defined while differentiating a tempo, a rhythm, an interval, a scale, a key, an expression mark, and the like, and are individually stored in association with titles.

Moreover, each piece of the musical performance information 305b is digital data, for example, defined in accordance with the musical instruments digital interface (MIDI) standard and the like, and specifically, includes: header information in which the number of tracks, a resolution (number of tick counts) of a quarter note, and the like are defined; track information composed of an event and timing, which are supplied to a sound source (for example, a musical instrument and the like) assigned to each part; and the like. As the event of this track information, for example, there is information for instructing a change of the tempo or the rhythm, or instructing Note On/OFF.

The animation processing unit 306 includes: a first skeleton information obtaining unit 306a; an image obtaining unit 306b; a second skeleton information obtaining unit 306c; a skeleton point setting unit 306d; a region specifying unit 306e; a reference point position specifying unit 306f; a control point setting unit 306g; a frame creating unit 306h; a back surface image creating unit 306i; and the animation creating unit 306j.

The first skeleton information obtaining unit 306a obtains the model skeleton information related to the skeleton of the moving subject model of the reference image P1.

Specifically, the first skeleton information obtaining unit 306a obtains the motion information 305a from the storage unit 305, implements thinning processing to create a line image composed of pixels with a width of a predetermined number (for example, one) for image data of the reference image P1 related to the motion information 305a concerned, that is, of the reference image P1 (refer to FIG. 8A) showing the position of the model region 1A of the moving subject model, and creates a model skeleton line image P1a (refer to FIG. 8B) as the model skeleton information.

For example, the first skeleton information obtaining unit 306a applies the Hilditch algorithm to the image data of the reference image P1, and repeats a search and deletion of images which satisfy a variety of conditions such that, in the image concerned, end points as boundary points should not be deleted, isolated points should be preserved, and connectedness should be preserved, thereby creating the model skeleton line image P1a.

Note that the above-described obtaining processing for the model skeleton information by the first skeleton information obtaining unit 306a is merely an example, and information obtaining processing of the present invention thereby is not limited to this, and is changeable appropriately and arbitrarily. Moreover, the Hilditch algorithm is applied as the thinning processing; however, this is merely an example, and thinning processing of the present invention is not limited to this, and is changeable appropriately and arbitrarily. Moreover, in the model skeleton line image P1a shown in FIG. 8B, the model region 1A is schematically shown by a broken line.

Moreover, in the reference image P1, the subject clipped image and the mask image P2, the above-described thinning processing and a variety of image processing to be described later are performed, for example, while taking an upper left corner portion of each thereof as an original coordinate (that is, taking an X-axis in a left and right direction, and a Y-axis in an up and down direction).

The image obtaining unit 306b obtains a still image for use in the animation creation processing.

That is to say, as an obtaining unit, the image obtaining unit 306b obtains the subject clipped image (the subject image) in which the subject region including the subject is clipped from the subject existing image in which the background and the subject exist. Specifically, the image obtaining unit 306b obtains the image data of the subject clipped image, which is created by the subject clipping unit 304, and the image data of the mask image P2, which is associated with the image data of the subject clipped image concerned.

Note that, for example, the subject clipped image is an image showing a state where the person as the subject is viewed from a predetermined direction.

The second skeleton information obtaining unit 306c obtains subject skeleton information related to a skeleton of the subject of the subject clipped image.

That is to say, the second skeleton information obtaining unit 306c obtains the subject skeleton information related to the skeleton of the subject of the subject clipped image obtained by the image obtaining unit 306b. Specifically, the second skeleton information obtaining unit 306c implements thinning processing to create a line image composed of pixels with a width of a predetermined number (for example, one) for image data of the mask image P2 obtained by the image obtaining unit 306b, that is, image data of the mask image P2, which is associated with the image data of the subject clipped image, and indicates the position of the subject region 2A in the subject clipped image, and creates a subject skeleton line image (not shown) as the subject skeleton information.

For example, in a similar way to the first skeleton information obtaining unit 306a, the second skeleton information obtaining unit 306c applies the Hilditch algorithm to the image data of the mask image P2, and repeats a search and deletion of images which satisfy a variety of conditions such that, in the image concerned, end points as boundary points should not be deleted, isolated points should be preserved, and connectedness should be preserved, thereby creating the subject skeleton line image.

Note that the above-described obtaining processing for the subject skeleton information by the second skeleton information obtaining unit 306c is merely an example, and information obtaining processing of the present invention thereby is not limited to this, and is changeable appropriately and arbitrarily. Moreover, the Hilditch algorithm is applied as the thinning processing; however, this is merely an example, and thinning processing of the present invention is not limited to this, and is changeable appropriately and arbitrarily.

The skeleton point setting unit 306d sets a plurality of model skeleton points S in the model region 1A of the reference image P1.

That is to say, based on the model skeleton information obtained by the first skeleton information obtaining unit 306a, the skeleton point setting unit 306d sets the plurality of model skeleton points S associated with the skeleton of the moving subject model in the model region 1A of the reference image P1. Specifically, based on the image data of the reference image P1, the skeleton point setting unit 306d specifies model skeleton reference points R on outline portions of the model region 1A, in which a plurality of spots composing a human body are connected to each other, and sets the plurality of model skeleton points S . . . in the model region 1A based on the skeleton reference points R.

As the model skeleton reference points R, for example, a model crotch reference point R1, left and right model armpit reference points R2 and R3 and the like are mentioned.

Here, a description is made of a specifying method of the model crotch reference point R1 by the skeleton point setting unit 306d.

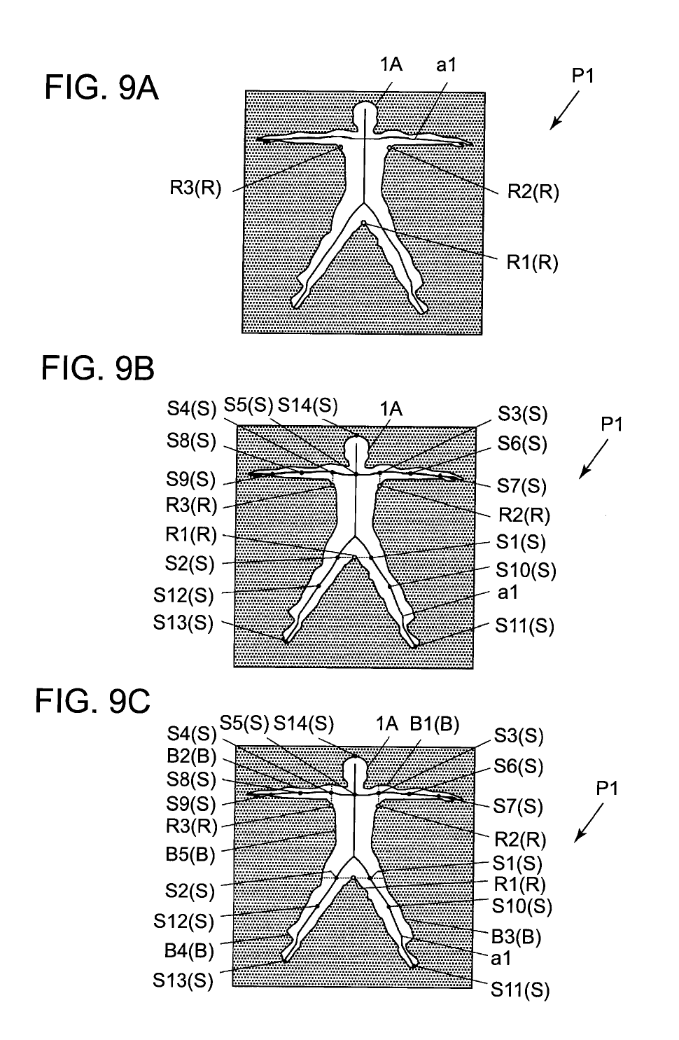

The skeleton point setting unit 306d specifies the model crotch reference point R1 at a portion where the left and right legs composing the moving subject model (the human body) are connected to each other (refer to FIG. 9A). That is to say, for example, the skeleton point setting unit 306d specifies a gravitational center position in a predetermined range (for example, a range of approximately 4/6 to ⅚ among six portions obtained by equally dividing the reference image P1 in the y-axis direction (the up and down direction) on a lower side of the reference image P1. Then, the skeleton point setting unit 306d scans the reference image P1 from the specified gravitational center position in a negative direction (an upper direction) of the y-axis, and specifies an intersection of a line thus scanned with the outline, which composes the model region 1A, as a first outline point. Then, the skeleton point setting unit 306d scans the outline from the specified first outline point in the respective directions (both of the upper direction and the lower direction) of the y-axis by a predetermined number of pixels, and based on the following Expression (1), searches a position where an evaluation value “DD” becomes maximum in a route portion thus scanned in the outline, and specifies the searched position as the model crotch reference point R1.

Note that, as a searching method of the evaluation value “DD”, for example, forward differentiation of a table coordinate of a y-coordinate along the route portion in such a scanned range in the outline is used. Specifically, for example, the skeleton point setting unit 306d sets a forward and back reference range at an arbitrary position “k” (k: 0 to n) at “2”, and based on the following Expression (1), obtains a position “k” where the value of the evaluation value “DD” becomes the maximum. Then, in the skeleton point setting unit 306d, if the position “k” where the evaluation value “DD” becomes the maximum is defined as “maxK”, then the coordinate of the model crotch reference point R1 is defined by “tr(maxK)”.

Note that, in the following Expression (1), “tr(n)·y” represents a y-coordinate at a position n in a route “tr”.

DD=−(yd_(k−2)+yd_(k−1))+(yd_(k+1)+yd_(k+2))

yd_(n)=tr(n+1)·y−tr(n)·y Expression (1);

Moreover, for example, the skeleton point setting unit 306d scans the model region 1A of the reference image P1 from the model crotch reference point R1 in the respective directions (both of the leftward direction and the rightward direction) of the x-axis, and for each of the directions, specifies an intersection of a line thus scanned with a model skeleton line a1 of the model skeleton line image P1a created by the first skeleton information obtaining unit 306a. Then, the skeleton point setting unit 306d sets both of the specified intersections as left and right model hip joint skeleton points S1 and S2 (refer to FIG. 9B).

Next, a description is made of a specifying method of the left and right model armpit reference points R2 and R3 by the skeleton point setting unit 306d.

The skeleton point setting unit 306d specifies the left and right model armpit reference points R2 and R3 at portions where the respective left and right arms and a body, which compose the moving subject model (the human body), are connected to each other (refer to FIG. 9A). That is to say, for example, the skeleton point setting unit 306d scans the reference image P1 in the respective directions outside of the left and right hip joint skeleton points S1 and S2 taken as references along the x-axis direction from the respective hip joint skeleton points S1 and S2, and individually specifies intersections of lines thus scanned with the outline, which composes the model region 1A, as second outline points. Then, the skeleton point setting unit 306d scans the outline from the respective specified second outline points in the negative direction (the upper direction) of the y-axis by a predetermined number of pixels, and based on the following Expressions (2) and (3), specifies the left and right model armpit reference points R2 and R3.

Note that, in a similar way to the above-mentioned specifying method of the model crotch reference point R1, as a searching method of the evaluation value “DD”, forward differentiation of table coordinates of the x-coordinate and the y-coordinate along the route portions in the outlines on both of the left and right sides are used.

Specifically, in the case of specifying the right model armpit reference point R3 on the left side when viewed from the front of the reference image P1, the skeleton point setting unit 306d sets a forward and back reference range at an arbitrary position “k” (k: 0 to n) at “2”, and based on the following Expression (2), obtains a position “k” where the value of the evaluation value “DD” becomes the maximum. Then, in the skeleton point setting unit 306d, if the position “k” where the evaluation value “DD” becomes the maximum is defined as “maxK”, then the coordinate of the right model armpit reference point R3 is defined by “tr(maxK)”. Note that, in the following Expression (2), a coordinate of a position n in the left-side route “tr” can be obtained by (tr(n)·x, tr(n)·y)

DD=−(d_{—}tr(k−2)·y+d_{—}tr(k−1)·y)−(d_{—}tr(k+1)·x+d_{—}tr(k+2)·x)

d_{—}tr(n)=tr(n+1)−tr(n) Expression (2);

In a similar way, in the case of specifying the left model armpit reference point R2 on the right side when viewed from the front of the reference image P1, the skeleton point setting unit 306d sets a forward and back reference range at an arbitrary position “k” (k: 0 to n) at “2”, and based on the following Expression (3), obtains a position “k” where the value of the evaluation value “DD” becomes the maximum. Then, in the skeleton point setting unit 306d, if the position “k” where the evaluation value “DD” becomes the maximum is defined as “maxK”, then the coordinate of the left model armpit reference point R2 is defined by “tr(maxK)”. Note that, in the following Expression (3), a coordinate of a position n in the right-side route “tr” can be obtained by (tr(n) x, tr(n) y).

DD=−(d_{—}tr(k−2)*y+d_{—}tr(k−1)·y)+(d_{—}tr(k+1)*x+d_{—}tr(k+2)·x)

d_{—}tr(n)=tr(n+1)−tr(n) Expression (3);

Moreover, the skeleton point setting unit 306d scans the model region 1A of the reference image P1 individually from the left and right model armpit reference points R2 and R3 in the negative direction (the upper direction) of the y-axis, and specifies the respective intersections of lines thus scanned with the model skeleton line a1 of the model skeleton image P1a. Then, the skeleton point setting unit 306d sets both of the specified intersections as left and right model shoulder skeleton points S3 and S4 (refer to FIG. 9B).

Furthermore, for example, the skeleton point setting unit 306d specifies a midpoint between the left and right model shoulder skeleton points S3 and S4 in the model region 1A of the reference image P1. Then, the skeleton point setting unit 306d sets the specified midpoint as a model shoulder center skeleton point S5 (refer to FIG. 9B).

Moreover, for example, the skeleton point setting unit 306d scans the model skeleton line a1 of the model skeleton line image P1a from the left model shoulder skeleton point S3 in the model region 1A of the reference image P1, and specifies positions between which a predetermined ratio is established while taking a distance to a tip end portion on a left hand side as a reference. Then, the skeleton point setting unit 306d sets a left model elbow skeleton point S6 and a left model wrist skeleton point S7 at the specified positions (refer to FIG. 9B).

In a similar way, for example, the skeleton point setting unit 306d scans the model skeleton line a1 of the model skeleton line image P1a from the right model shoulder skeleton point S4 in the model region 1A of the reference image P1, and specifies positions between which a predetermined ratio is established while taking a distance to a tip end portion on a right hand side as a reference. Then, the skeleton point setting unit 306d sets a left model elbow skeleton point S6 and a left model wrist skeleton point S7 at the specified positions (refer to FIG. 9B). Then, the skeleton point setting unit 306d sets a right model elbow skeleton point S8 and a right model wrist skeleton point S9 at the specified positions (refer to FIG. 9B).

Moreover, for example, the skeleton point setting unit 306d scans the model skeleton line a1 of the model skeleton line image P1a from the left model hip joint skeleton point S1 in the model region 1A of the reference image P1, and specifies positions between which a predetermined ratio is established while taking a distance to a tip end portion on a left foot side as a reference. Then, the skeleton point setting unit 306d sets a left model knee skeleton point S10 and a left model ankle skeleton point S11 at the specified positions (refer to FIG. 9B).

In a similar way, for example, the skeleton point setting unit 306d scans the model skeleton line a1 of the model skeleton line image P1a from the right model hip joint skeleton point S2 in the model region 1A of the reference image P1, and specifies positions between which a predetermined ratio is established while taking a distance to a tip end portion on a right foot side as a reference. Then, the skeleton point setting unit 306d sets a right model knee skeleton point S12 and a right model ankle skeleton point S13 at the specified positions (refer to FIG. 9B).

Moreover, for example, the skeleton point setting unit 306d scans the model region 1A of the reference image P1 from the model shoulder center skeleton point S5 in the negative direction (the upper direction) of the y-axis, and specifies an intersection of a line thus scanned with the outline composing the model region 1A. Then, the skeleton point setting unit 306d sets the specified intersection as a model vertex skeleton point S14 (refer to FIG. 9B).

Moreover, the skeleton point setting unit 306d sets a plurality of subject skeleton points I in the subject region of the subject clipped image.

That is to say, based on the subject skeleton information obtained by the second skeleton information obtaining unit 306c, the skeleton point setting unit 306d sets the plurality of subject skeleton points I, which are associated with the skeleton of the subject, in the subject region 2A of the mask image P2 (refer to FIG. 10A) allowed to correspond to the subject clipped image (refer to FIG. 10B). Specifically, in a similar way to the above-described processing for the model region 1A of the reference image P1, based on the image data of the mask image P2, the skeleton point setting unit 306d specifies subject skeleton reference points H on an outline portion of the subject region 2A, in which a plurality of spots composing the human body are connected to each other, and sets the plurality of subject skeleton points I . . . in the subject region 2A based on the skeleton reference points H concerned.

As the subject skeleton reference points H, for example, a subject crotch reference point H1, left and right subject armpit reference points H2 and H3 and the like are mentioned. Here, for example, the skeleton point setting unit 306d performs processing, which is similar to that of the specifying method of the model crotch reference point R1 and the left and right model armpit reference points R2 and R3, for the mask image P2, and in the subject region 2A of the mask image P2, specifies the subject crotch reference point H1 and the left and right subject armpit reference points H2 and H3.

Moreover, for example, the skeleton point setting unit 306d performs processing, which is similar to that of the setting method of left and right model hip joint skeleton points S1 and S2, the left and right model shoulder skeleton points S3 and S4, the model shoulder center skeleton point S5, the left and right model e-bow skeleton points S6 and S8, the left and right model wrist skeleton points S7 and S9, the left and right model knee skeleton points S10 and S12, the left and right model ankle skeleton points S11 and S13 and the model vertex skeleton point S14, for the mask image P2. Then, in the subject region 2A of the mask image P2 concerned, the skeleton point setting unit 306d sets left and right subject hip joint skeleton points I1 and I2, left and right subject shoulder skeleton points I3 and I4, a subject shoulder center skeleton point I5, left and right subject elbow skeleton points I6 and I8, left and right subject wrist skeleton points I7 and I9, left and right subject knee skeleton points I10 and I12, left and right subject ankle skeleton points I11 and I13 and a subject vertex skeleton point I14.

Note that the model skeleton reference points R, the model skeleton points S, the subject skeleton reference points H and the subject skeleton points I, which are described above, are merely examples, and those of the present invention are not limited to these, and are changeable appropriately and arbitrarily.

The region specifying unit 306e specifies regions B of representative spots, which compose the moving subject model, in the model region 1A of the reference image P1.

That is to say, in the model region 1A of the reference image P1, for example, the region specifying unit 306e individually specifies left and right model arm regions B1 and B2 respectively corresponding to the left and right arms, left and right model leg regions B3 and B4 respectively corresponding to the left and right legs, and a model body region B5 corresponding to the body and the head, as the regions B of the representative spots, which compose the moving subject model, based on the image data of the reference image P1 (refer to FIG. 9C).

Specifically, for example, the region specifying unit 306e scans the model region 1A from the left model shoulder skeleton point S3 in the respective directions (both of the upper direction and the lower direction) of the y-axis, and individually specifies intersections of lines thus scanned with the outline composing the model region 1A. Then, in the model region 1A, the region specifying unit 306e specifies a region, which is obtained by dividing the model region 1A by a segment connecting these two intersections to each other, and exists on an opposite side (a hand side) to the model shoulder center skeleton point S5, as the left model arm region B1 corresponding to the left arm of the human body. Subsequently, the region specifying unit 306e specifies the respective intersections of a straight line, which passes through the left model elbow skeleton point S6 and is extended along the y-axis direction, with the outline, and specifies a distance between the intersections concerned as a thickness (a width) of the left model arm region B1.

Moreover, for example, the region specifying unit 306e performs similar processing also for the right model arm region B2 corresponding to the right arm of the human body, and specifies the right model arm region B2 and a thickness of the right model arm region B2 concerned.

Moreover, for example, the region specifying unit 306e scans the model region 1A from the left model hip joint skeleton point S1 in the respective directions (both of the leftward direction and the rightward direction) of the x-axis, and individually specifies intersections of lines thus scanned with the outline composing the model region 1A. Then, in the model region 1A, the region specifying unit 306e specifies a region, which is obtained by dividing the model region 1A by a segment connecting these two intersections to each other, and exists on an opposite side (a foot side) to the model shoulder center skeleton point S5, as the left model leg region B3 corresponding to the left leg of the human body. Subsequently, the region specifying unit 306e specifies the respective intersections of a straight line, which passes through the left model knee skeleton point S10 and is extended along the x-axis direction, with the outline, and specifies a distance between the intersections concerned as a thickness (a width) of the left model leg region B3.

Moreover, for example, the region specifying unit 306e performs similar processing also for the right model leg region B4 corresponding to the right leg of the human body, and specifies the right model leg region B4 and a thickness of the right model leg region B4 concerned.

Moreover, for example, the region specifying unit 306e specifies a region, which remains as a result of that the left and right model arm regions B1 and B2 and the left and right model leg regions B3 and B4 are specified in the model region 1A, as the model body region B5. Moreover, for example, the region specifying unit 306e specifies a distance between the left and right model shoulder skeleton points S3 and S4 as a thickness of the model body region B5.

Moreover, the region specifying unit 306e specifies regions D of representative spots, which compose the subject region 2A, in the subject region 2A of the mask image P2.

That is to say, in the subject region 2A of the mask image P2, for example, the region specifying unit 306e individually specifies left and right subject regions D1 and D2 respectively corresponding to the left and right arms, left and right subject leg regions D3 and D4 respectively corresponding to the left and right legs, and a subject body region D5 corresponding to the body and the head, as the regions D of the representative spots, which compose the human body, based on the image data of the mask image P2 (refer to FIG. 10B).

Specifically, for example, the region specifying unit 306e performs processing, which is similar to that for above-described model region 1A of the reference image P1, for the mask image P2, and in the subject region 2A of the mask image P2 concerned, specifies the left and right subject regions D1 and D2, the left and right subject leg regions D3 and D4 and the subject body region D5, and thicknesses of the respective regions D1 to D5.

Note that, in the mask image P2 shown in FIG. 10B, a subject skeleton line a2 related to the subject skeleton line image (not shown) is shown.

Note that the above-described regions B (D) of the representative spots which compose the human body are merely examples, and those of the present invention are not limited to these, and are changeable appropriately and arbitrarily. Moreover, such specifying methods of the regions B (D) and such specifying methods of the thicknesses of the respective regions B (D) are also merely examples, and those of the present invention are not limited to these, and are changeable appropriately and arbitrarily.

The reference point position specifying unit 306f specifies the positional information related to the respective positions of the plurality of motion reference points Q . . . in the model region 1A of the moving subject model of the reference image P1.

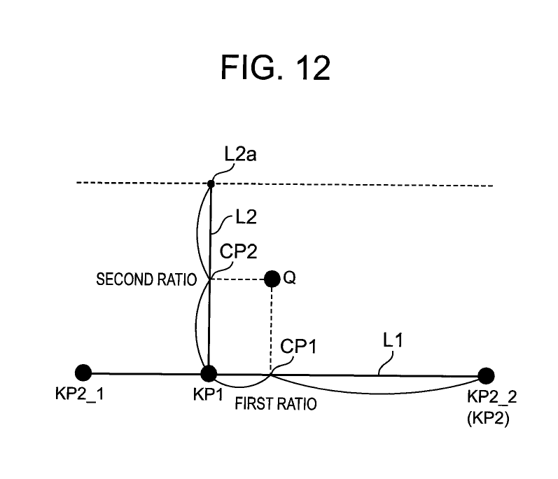

That is to say, as a specifying unit, the reference point position specifying unit 306f specifies the positional information related to the respective positions of the plurality of motion reference points Q . . . in the model region 1A based on the model skeleton information related to the skeleton of the moving subject model of the reference image P1. Specifically, the reference point position specifying unit 306f specifies, as the positional information, information related to relative positional relationships of the plurality of model skeleton points S . . . , which are set by the skeleton point setting unit 306d, with respect to the plurality of respective motion reference points Q . . . (refer to FIG. 12).

For example, for each of the plurality of motion reference points Q . . . , the reference point position specifying unit 306f specifies a first model skeleton point “KP1” that exists at a nearest position among the plurality of model skeleton points S . . . . Then, the reference point position specifying unit 306f specifies second model skeleton points “KP2” which sandwich the motion reference point Q (a motion reference point Q nearest the specified first model skeleton point) as a processing target in a predetermined direction together with the first model skeleton point concerned. Specifically, the reference point position specifying unit 306f specifies two model skeleton points S and S, which exist at positions near the specified first model skeleton point, as candidate skeleton points “KP2_1” and “KP2_2”. Subsequently, the reference point position specifying unit 306f creates the respective vectors “KP2_1-KP1”, “KP2_2-KP1” and “Q-KP1”, in which the first model skeleton point is defined as a starting point, and the candidate skeleton points “KP2_1” and “KP2_2” and the motion reference point Q as the processing target are defined as end points, respectively. Then, the reference point position specifying unit 306f individually calculates inner products “IP1” and “IP2” of the respective vectors directed to the respective candidate skeleton points “KP2_1” and “KP2_2” and the vector directed to the motion reference point Q as the processing target in accordance with a predetermined arithmetic expression. Then, the reference point position specifying unit 306f specifies the second model skeleton points while taking sizes of the calculated two inner products “IP1” and “IP2” as references. That is to say, if both of the two inner products “IP1” and “IP2” are “0” or less, then the reference point position specifying unit 306f defines a skeleton point, which is nearer the motion reference point Q between the two candidate skeleton points “KP2_1” and “KP2_2”, as the second model skeleton point “KP2”. Moreover, if only the inner product “IP1” is larger than “0”, then the reference point position specifying unit 306f defines the candidate skeleton point “KP2_1” as the second model skeleton point “KP2”. Otherwise, the reference point position specifying unit 306f defines the candidate skeleton point “KP2_2” as the second model skeleton point “KP2”.

Then, the reference point position specifying unit 306f specifies a position of an intersection “CP1” of a first segment “L1”, which connects the first model skeleton point “KP1” and the second model skeleton point “KP2” to each other, and of a straight line, which is perpendicular to the first segment “L1” concerned and passes through the motion reference point Q. Then, the reference point position specifying unit 306f defines a length of the first segment “L1” as “1”, and specifies, as a first ratio, a ratio of distances individually from the first model skeleton point “KP1” and the second model skeleton point “KP2” to the intersection “CP1”.

As described above, the reference point position specifying unit 306f specifies the positional information including the information related to the relative positional relationships of the first and second model skeleton points “KP1” and “KP2” (two model skeleton points S and S) with respect to the motion reference point Q.

Moreover, the reference point position specifying unit 306f specifies an outline portion of a spot including two model skeleton points S and S in the model region 1A.

That is to say, among the left and right model arm regions B1 and B2, the left and right model leg regions B3 and B4 and the model body region B5, the reference point position specifying unit 306f specifies the region B (for example, the left model arm region B1 or the like) including the motion reference point Q and the first and second model skeleton points “KP1” and “KP2”, which serve as the processing targets, and specifies the length of the region B concerned. Then, the reference point position specifying unit 306f specifies a second segment “L2”, which has a half-length of the specified length, and is a segment, which is perpendicular to the segment “L1”, and is extended to the motion reference point Q side from either one model skeleton point (for example, the first model skeleton point “KP1” or the like) of the first and second model skeleton points “KP1” and “KP2”. That is to say, an end portion “L2a” on an opposite side to the model skeleton point S of the second segment “L2” exists on the outline of the spot including the first and second model skeleton points “KP1” and “KP2”.

Subsequently, the reference point position specifying unit 306f specifies a position of an intersection “CP2” of the second segment “L2” and a straight line, which is perpendicular to the second segment “L2” concerned, and passes through the motion reference point Q. Then, the reference point position specifying unit 306f defines a length of the second segment “L2” as “1”, and specifies, as a second ratio, a ratio of distances individually from the first model skeleton point “KP1” and the end portion “L2a” of the second segment “L2” to the intersection “CP2”.

As described above, the reference point position specifying unit 306f specifies the positional information including the information related to the relative positional relationships of the outline portions of the region B, which includes the first and second model skeleton points “KP1” and “KP2” (two model skeleton points S and S) in the model region 1A, with respect to each of the motion reference points Q.

The control point setting unit 306g sets the plurality of motion control points J at the respective positions individually corresponding to the plurality of motion reference points Q . . . in the subject region of the subject clipped image.

That is to say, as a control point setting unit, the control point setting unit 306g sets the plurality of motion control points J, which are related to the motion control for the subject region 2A, at the respective positions individually corresponding to the plurality of motion reference points Q . . . in the subject region 2A of the mask image P2 based on the positional information related to the respective positions of the plurality of motion reference points Q . . . in the model region 1A specified by the reference point position specifying unit 306f and on the subject skeleton information obtained by the second skeleton information obtaining unit 306c. Specifically, the control point setting unit 306g reads out the motion information 305a of the moving subject model (for example, an animal) from the storage unit 305, and sets the motion control points J individually corresponding to the plurality of motion reference points Q . . . of the reference frame (for example, the first frame or the like) defined in the motion information 305a concerned.

For example, the control point setting unit 306g sets the plurality of motion control points J . . . in the subject region 2A based on the information, which is related to the relative positional relationships of the plurality of model skeleton points S . . . specified by the reference point position specifying unit 306f with respect to the plurality of motion reference points Q . . . , and on the plurality of subject skeleton points T . . . set in the subject region 2A by the skeleton point setting unit 306d.

That is to say, among the plurality of subject skeleton points I set in the subject region 2A by the skeleton point setting unit 306d, the control point setting unit 306g specifies two subject skeleton points (for example, first and second subject skeleton points I and I corresponding to two model skeleton points (for example, the first and second model skeleton points “KP1” and “KP2”) S and S, which are adjacent to each other and are set so as to sandwich each of the plurality of motion reference points Q . . . specified by the reference point position specifying unit 306f. Moreover, in the subject region 2A, the control point setting unit 306g specifies the corresponding region D (for example, the left subject arm region D1 or the like) corresponding to the region B of the spot including the adjacent two model skeleton points (for example, the first and second model skeleton points “KP1” and “KP2”) S and S.

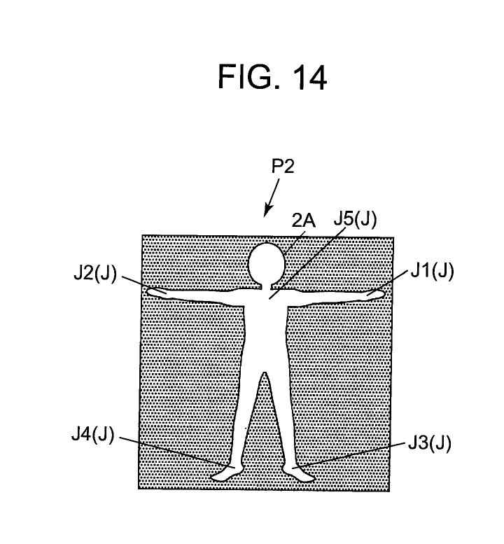

Then, the control point setting unit 306g reflects the relative positional relationships of the first and second model skeleton points S and S with respect to each of the motion reference points Q and the relative positional relationships of the outline portions of the region B of the spot including the first and second model skeleton points S and S with respect thereto onto the two subject skeleton points I and I specified in the subject region 2A and onto the outline portions of the corresponding region D including the two subject skeleton points I and I. That is to say, in the subject region 2A, the control point setting unit 306g has relative positional relationships, which correspond to the relative positional relationships of the two adjacent model skeleton points S and S with respect to each of the motion reference points Q, for the two subject skeleton points I and I. In addition, in the corresponding region D, the control point setting unit 306g sets each of the motion control points J (for example, the left wrist motion control point J or the like) at a position that has, with respect to the outline portions of the corresponding region D, the relative positional relationships corresponding to the relative positional relationships of the outline portions of the spot including the two model skeleton points S and S with respect to each of the motion reference points Q (refer to FIG. 14).

Then, the control point setting unit 306g sets the respective motion control points J in the subject region of the subject clipped image in accordance with the respective coordinates of the motion control points J set in the subject region 2A of the mask image P2 so that the motion control points J in the subject region concerned can be allowed to correspond to the motion control points J set in the subject region 2A concerned.

Moreover, the control point setting unit 306g individually sets the motion control points J in the subject region of the subject clipped image, and may thereby automatically set the motion control points J also at predetermined positions in a back surface image corresponding to the subject clipped image concerned, the motion control points J individually corresponding to the predetermined positions.

Furthermore, the control point setting unit 306g may set the motion control points J for all of the plurality of motion reference points Q . . . defined in the motion information 305a, the motion control points J corresponding to all of the motion reference points Q . . . concerned, or alternatively, may set only the motion control points J corresponding to a predetermined number of representative motion reference points Q such as the center portion and respective tip end portions of the subject.

Note that, after the setting of the motion control points J by the control point setting unit 306g is performed, correction (change) of the setting positions of the motion control points J may be accepted based on a predetermined operation for the operation input unit 202 of the user terminal 2 by the user.

The frame creating unit 306h sequentially creates a plurality of reference frame images (not shown) which compose the animation.

That is to say, based on the motions of the plurality of motion reference points Q . . . of the motion information 305a, the frame creating unit 306h moves the plurality of motion control points J . . . set in the subject region of the subject clipped image by the control point setting unit 306g, and creates a plurality of frame images in which the subject region is deformed in accordance with the motions of the motion control points J concerned. Specifically, the frame creating unit 306h moves the plurality of motion control points J . . . set in the subject image of the subject clipped image so as to allow the motion control points J concerned to follow the motions of the plurality of motion reference points Q . . . of the motion information 305a designated by the animation processing unit 306. For example, the frame creating unit 306h sequentially obtains the coordinate information of the plurality of motion reference points Q . . . which move at a predetermined time interval in accordance with the motion information 305a, and calculates coordinates of the respective motion control points J individually corresponding to the motion reference points Q concerned. At this time, the frame creating unit 306h moves and deforms a predetermined image region (for example, a triangular region or a rectangular mesh-like region), which is set in the subject region, while taking at least one of the motion control points J as a reference, thereby creating the reference frame image (not shown).

Note that such processing for moving and deforming the predetermined image regions while taking the motion control points J as references is a technology known in public, and accordingly, a detailed description thereof is omitted here.

Moreover, the frame creating unit 306h creates interpolation frame images (not shown), each of which interpolates between two reference frame images created based on the plurality of motion control points J . . . individually corresponding to the already moved motion reference points Q, the two adjacent reference frames being adjacent to each other along the time axis. That is to say, the frame creating unit 306h creates a predetermined number of the interpolation frame images, each of which interpolates between two reference frames, so that the plurality of frame images can be played at a predetermined playing frame rate (for example, 30 fps and the like) by the animation playing unit 306j.

Specifically, in the two reference frame images adjacent to each other, the frame creating unit 306h sequentially obtains a progress degree of musical performance of a predetermined music to be performed by the animation playing unit 306j, and in response to the progress degree concerned, sequentially creates the interpolation frame image to be played between the two reference frames adjacent to each other. For example, the frame creating unit 306h obtains tempo setting information and the resolution (number of tick counts) of the quarter note based on the music information 305b according to the MIDI standard, and converts an elapsed time of the musical performance of the predetermined music to be performed by the animation playing unit 306j into the number of tick counts. Subsequently, based on the number of tick counts corresponding to the elapsed time of the musical performance of the predetermined music, the frame creating unit 306h calculates a relative progress degree of the musical performance of the predetermined music between the two reference frame images which are adjacent to each other and are synchronized with predetermined timing (for example, a first beat of each bar, and the like), for example, by a percentage. Then, in response to the relative progress degree of the musical performance of the predetermined music, the frame creating unit 306h changes weighting to the two reference frame images concerned adjacent to each other, and creates the interpolation frame images.

Note that such processing for creating the interpolation frame images is a technology known in public, and accordingly, a detailed description thereof is omitted here.

Moreover, the creation of the reference frame images and the interpolation frame images by the frame creating unit 306h is performed also for the image data of the mask image P1 and the alpha map in a similar way to the above.

The back surface image creating unit 306i creates the back surface image (not shown) that shows a back side (back surface side) of the subject in a pseudo manner.

That is to say, the back surface image creating unit 306i draws a subject corresponding region D corresponding to the subject region of the subject clipped image in the back surface image, for example, based on color information of an outline portion of the subject region of the subject clipped image.

The animation playing unit 306j plays each of the plurality of frame images created by the frame creating unit 306h.

That is to say, the animation playing unit 306j automatically performs the predetermined music based on the musical performance information 305b designated based on a predetermined operation for the operation input unit 202 of the user terminal 2 by the user, and in addition, plays each of the plurality of frame images at the predetermined timing of the predetermined music. Specifically, the animation playing unit 306j converts the digital data of the musical performance information 305b of the predetermined music into the analog data by the D/A converter, and automatically performs the predetermined music. At this time, the animation playing unit 306j plays the two reference frame images adjacent to each other so that the reference frame images can be synchronized with the predetermined timing (for example, the first beat and respective beats of each bar, and the like), and in addition, in response to the relative progress degree of the musical performance of the predetermined music between the two reference frame images adjacent to each other, plays each of the interpolation frame images corresponding to the progress degree concerned.

Note that the animation playing unit 306j may play a plurality of the frame images, which are related to the subject image, at a speed designated by the animation processing unit 306. In this case, the animation playing unit 306j changes the timing for synchronizing the two reference frame images adjacent to one another therewith, thereby changes the number of frame images to be played within a predetermined unit time, and varies a speed of the motion of the subject image.

### <Animation Creation Processing>

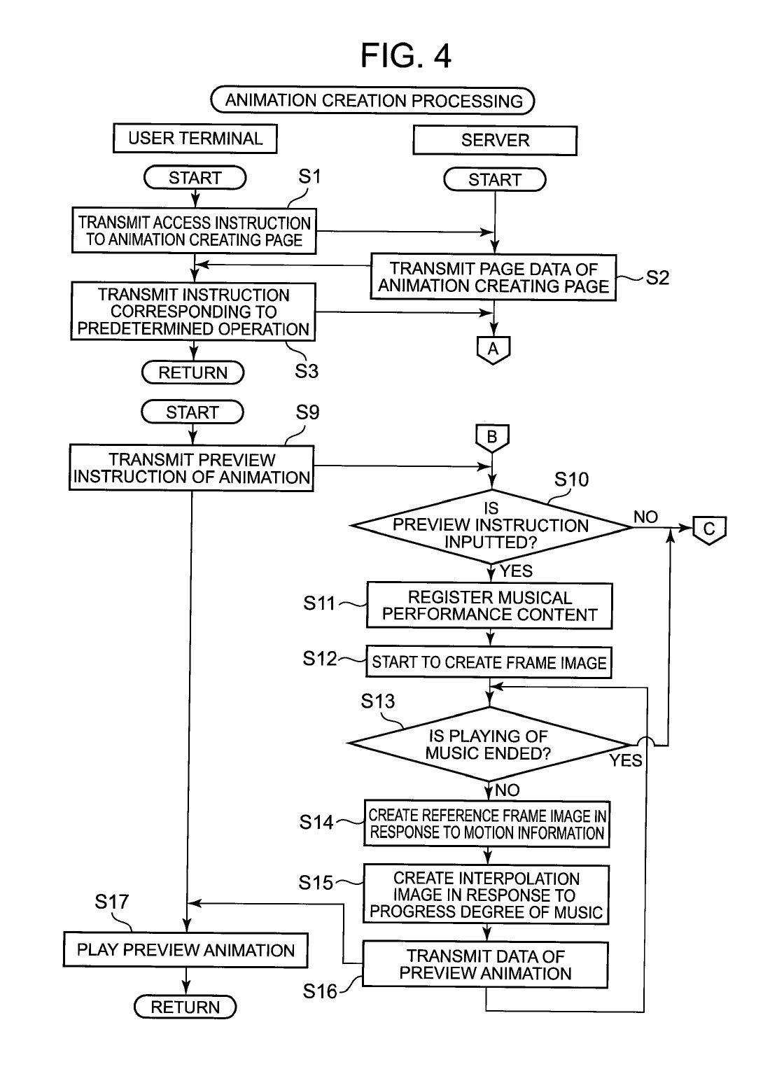

Next, a description is made of the animation creation processing, which uses the user terminal 2 and the server 3, with reference to FIG. 4 to FIG. 14.

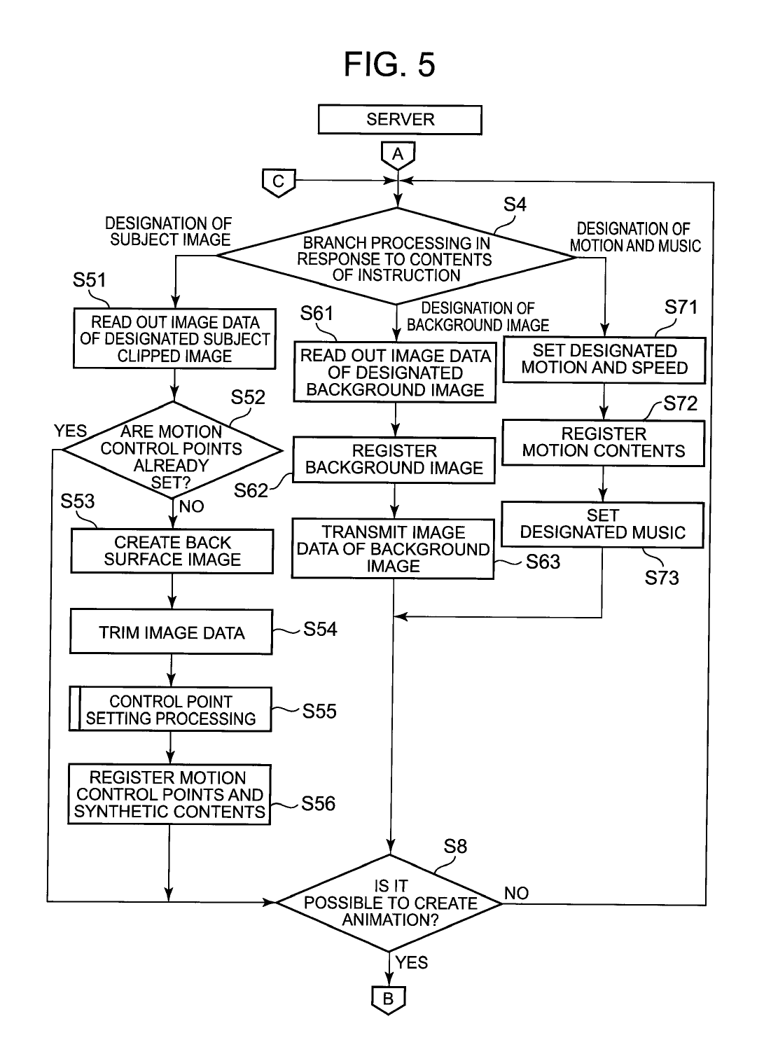

Here, FIG. 4 and FIG. 5 are flowcharts showing an example of operations related to the animation creation processing.

Note that, in the following description, it is assumed that the image data of the subject clipped image, which is created from the image data of the subject existing image, and the image data of the mask image P2, which corresponds to the subject clipped image concerned, are stored in the storage unit 305 of the server 3.

As shown in FIG. 4, upon receiving an input of an access instruction to the animation creating page, which is to be established by the server 3, the input being made based on a predetermined operation for the operation input unit 202 by the user, the CPU of the central control unit 201 of the user terminal 2 transmits the access instruction concerned to the server 3 through the predetermined communication network N by the communication control unit 206 (Step S1).

When the access instruction, which is transmitted from the user terminal 2, is received by the communication control unit 303 of the server 3, the CPU of the central control unit 301 transmits the page data of the animation creating page to the user terminal 2 through the predetermined communication network N by the communication control unit 303 (Step S2).

Then, when the page data of the animation creating page is received by the communication control unit 206 of the user terminal 2, the display unit 203 displays a screen (not shown) of the animation creating page based on the page data of the animation creating page.

Next, based on a predetermined operation for the operation input unit 202 by the user, the central control unit 201 of the user terminal 2 transmits an instruction signal, which corresponds to each of various buttons operated in the screen of the animation creating page, to the server 3 through the predetermined communication network N by the communication control unit 206 (Step S3).

As shown in FIG. 5, the CPU of the central control unit 301 of the server 3 branches the processing in response to contents of the instruction from the user terminal 2 (Step S4) Specifically, in the case where the instruction from the user terminal 2 has contents regarding designation of the subject image (Step S4: designation of the subject image), the CPU of the central control unit 301 shifts the processing to Step S51. Moreover, in the case where the instruction concerned has contents regarding designation of the background image (Step S4: designation of the background image), the CPU concerned shifts the processing to Step S61. Furthermore, in the case where the instruction concerned has contents regarding designation of the motion and the music (Step S4: designation of the motion and the music), the CPU concerned shifts the processing to Step S71.

### <Designation of Subject Image>

In the case where, in Step S4, the instruction from the user terminal 2 has the contents regarding the designation of the subject image (Step S4: designation of the subject image), then from among the image data of the subject clipped image, which is stored in the storage unit 305, the image obtaining unit 306a of the animation processing unit 306 reads out and obtains the image data of the subject clipped image designated by the user (Step S51).

Next, the control point setting unit 306g determines whether or not the motion control points J are already set in the subject regions 2A of the obtained subject clipped image and mask image P2 (Step S52).

In the case where, in Step S52, it is determined by the control point setting unit 306g that the motion control points J are not set (Step S52: NO), the animation processing unit 306 performs back surface image creation processing for creating the back surface image (not shown) that shows the back side of the image of the subject region of the subject clipped image in the pseudo manner (Step S53).

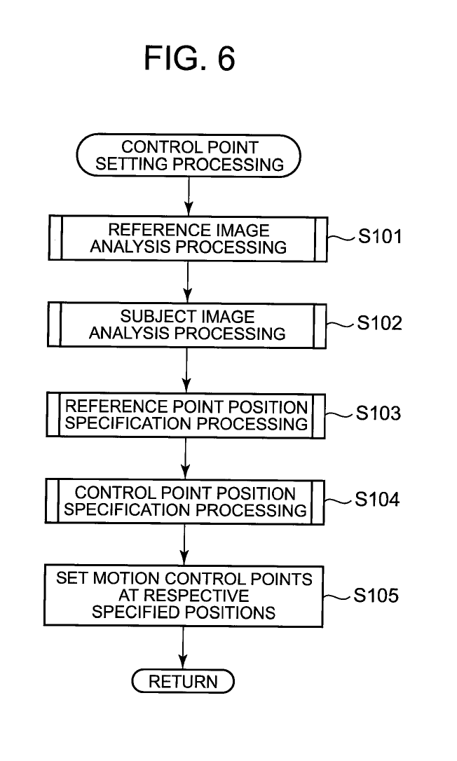

Next, the CPU of the central control unit 301 transmits the image data of the subject clipped image, which is associated with the created back surface image, to the user terminal 2 through the predetermined communication network N by the communication control unit 303 (Step S54). Thereafter, the control point setting unit 306g performs control point setting processing (refer to FIG. 6) for setting the plurality of motion control points J in the respective subject regions 2A of the subject clipped image and the mask image P2 (Step S55).

Note that the control point setting processing will be described later.

Then, the animation playing unit 306j registers the motion control points J . . . , which are set for the subject region concerned, and in addition, synthetic contents such as a synthetic position and size of the image of the subject region 2A in a predetermined storage unit (for example, a predetermined memory and the like) (Step S56).

Thereafter, the CPU of the central control unit 301 shifts the processing to Step S8. Contents of processing of Step S8 will be described later.

Note that, when it is determined in Step S52 that the motion control points J are already set (Step S52: YES), the CPU of the central control unit 310 skips the processing of Step S53 to 356, and shifts the processing to Step S8.

### <Designation of Background Image>

In the case where, in Step S4, the instruction from the user terminal 2 has the contents regarding the designation of the background image (Step S4: designation of the background image), the animation playing unit 306j of the animation processing unit 306 reads out image data of a desired background image (other image) based on a predetermined operation for the operation input unit 202 by the user (Step S61), and registers the image data of the background image concerned as the background of the animation in the predetermined storage unit (Step S62).

Specifically, a designation instruction for any one piece of image data among the plurality of image data in the screen of the animation creating page displayed on the display unit 203 of the user terminal 2, the one piece of image data being designated based on a predetermined operation for the operation input unit 202 by the user, is inputted to the server 3 through the communication network N and the communication control unit 303. The animation playing unit 306 reads out and obtains such image data of the background image related to the designation instruction concerned from the storage unit 305 (Step S61), and thereafter, registers the image data of the background image concerned as the background of the animation (Step S62).

Next, the CPU of the central control unit 301 transmits the image data of the background image to the user terminal 2 through the predetermined communication network N by the communication control unit 303 (Step S63).

Thereafter, the CPU of the central control unit 301 shifts the processing to Step S8. The contents of the processing of Step S8 will be described later.

### <Designation of Motion and Music>

In the case where, in Step S4, the instruction from the user terminal 2 has the contents regarding the designation of the motion and the music (Step S4: designation of the motion and the music), the animation processing unit 306 sets the motion information 305a and the speed of the motion based on a predetermined operation for the operation input unit 202 by the user (Step S71).

Specifically, a designation instruction for any one model name (for example, a hula and the like) among model names of a plurality of motion models in the screen of the animation creating page displayed on the display unit 203 of the user terminal 2, the one model name being designated based on a predetermined operation for the operation input unit 202 by the user, is inputted to the server 3 through the communication network N and the communication control unit 303. The animation processing unit 306 sets the motion information 305a, which is associated with the model name of the motion model related to the designation instruction concerned, among the plural pieces of motion information 305a . . . stored in the storage unit 305. Note that, among the plural pieces of motion information 305a, for example, the animation processing unit 306 may automatically designate the motion information 305a set as a default and the motion information 305a designated previously.

Moreover, a designation instruction for any one speed (for example, a standard (unity magnification) and the like) among a plurality of motion speeds (for example, ½ time, standard, twice and the like) in the screen of the animation creating page displayed on the display unit 203 of the user terminal 2, the one speed being designated based on a predetermined operation for the operation input unit 202 by the user, is inputted to the server 3 through the communication network N and the communication control unit 303. The animation processing unit 306 sets the speed, which is related to the designation instruction concerned, as the speed of the motion of the subject image.

Thereafter, the animation playing unit 306j of the animation processing unit 306 registers the set motion information 305a and motion speed as contents of the motion of the animation in the predetermined storage unit (Step S72).

Next, the animation processing unit 306 sets the music, which is to be automatically performed, based on a predetermined operation for the operation input unit 202 by the user (Step S73).

Specifically, a designation instruction for any one music name among a plurality of music names in the screen of the animation creating page displayed on the display unit 203 of the user terminal 2, the one music name being designated based on a predetermined operation for the operation input unit 202 by the user, is inputted to the server 3 through the communication network N and the communication control unit 303. The animation processing unit 306 sets a music of the music name related to the designation instruction concerned.

Thereafter, the CPU of the central control unit 301 shifts the processing to Step S8. The contents of the processing of Step S8 will be described later.

In Step S8, the CPU of the central control unit 301 determines whether or not it is possible to create the animation in this state (Step S8). That is to say, the animation processing unit 306 of the server 3 determines whether or not it is possible to create the animation as a result of that a preparation to create the animation is made by performing registration of the motion control points J for the subject regions 2A, registration of the motion contents of the images of the subject regions 2A, registration of the background image, and the like based on the predetermined operations for the operation input unit 202 by the user.

Here, when it is determined that it is not possible to create the animation in this state (Step S8: NO), the CPU of the central control unit 301 returns the processing to Step S4, and branches the processing in response to the contents of the instruction from the user terminal 2 (Step S4).

Meanwhile, when it is determined that it is possible to create the animation in this state (Step S8: YES), then as shown in FIG. 4, the CPU of the central control unit 301 shifts the processing to Step S10.

In Step S10, the CPU of the central control unit 301 of the server 3 determines whether or not a preview instruction of the animation is inputted based on a predetermined operation for the operation input unit 202 of the user terminal 2 by the user (Step S10).

That is to say, in Step S9, the central control unit 201 of the user terminal 2 transmits the preview instruction of the animation, which is inputted based on the predetermined operation for the operation input unit 202 by the user, to the server 3 through the predetermined communication network N by the communication control unit 206 (Step S9).

Then, when the CPU of the central control unit 301 of the server 3 determines in Step S10 that the preview instruction of the animation is inputted (Step S10: YES), the animation playing unit 306j of the animation processing unit 306 registers, in the predetermined storage unit, the musical performance information 305b, which corresponds to the already set music name, as the information to be automatically performed together with the animation (Step S11).

Next, the animation processing unit 306 starts the musical performance of the predetermined music by the animation playing unit 306j based on the musical performance information 305b registered in the storage unit, and in addition, starts the creation of the plurality of frame images, which compose the animation, by the frame creating unit 306h (Step S12).

Subsequently, the animation processing unit 306 determines whether or not the musical performance of the predetermined music by the animation playing unit 306j is ended (Step S13).

Here, when it is determined that the musical performance of the music is not ended (Step S13: NO), the frame creating unit 306h of the animation processing unit 306 creates the reference frame images of the images of the subject region, which are deformed in response to the motion information 305a (Step S14). Specifically, the frame creating unit 306h individually obtains the coordinate information of the plurality of motion reference points Q . . . , which move at a predetermined time interval in accordance with the motion information 305a registered in the storage unit, and calculates coordinates of the respective motion control points J respectively corresponding to the motion reference points Q concerned. Then, the frame creating unit 306h sequentially moves the motion control points J to the calculated coordinates, in addition, moves and deforms the predetermined image region, which is set in the image of the subject region, in response to the movement of the motion control points J, and thereby creates the reference frame images.

Moreover, the animation processing unit 306 synthesizes the reference frame images and the background image with each other by using a publicly known image synthesis method. Specifically, for example, among the respective pixels of the background image, the animation processing unit 306 allows transmission of the pixels with the alpha value of “0”, and overwrites the pixels with the alpha value of “1” by pixel values of the pixels of the reference frame images, the pixels corresponding thereto. Moreover, among the respective pixels of the background image, with regard to the pixels with the alpha value of “0<α<1”, the animation processing unit 306 creates an image (background image×(1−α), in which the subject region of each of the reference frame images is clipped, by using a complement (1−α) of 1, thereafter, calculates a value obtained by blending the reference frame image with the single background color in the event of creating the reference frame image concerned by using the complement (1−α) of 1 in the alpha map, subtracts the value concerned from the reference frame image, and synthesizes a subtraction resultant with the image (background image×(1−α)) from which the subject region is clipped.

Subsequently, in response to the progress degree of the musical performance of the predetermined music to be performed by the animation playing unit 306j, the frame creating unit 306h creates the interpolation frame image that interpolates between two reference frame images adjacent to each other (Step S15). Specifically, the frame creating unit 306h sequentially obtains the progress degree of the musical performance of the predetermined music, which is to be performed by the animation playing unit 306j, in the two reference frame images adjacent to each other, and in response to the progress degree concerned, sequentially creates the interpolation frame images, each of which is to be played between the two reference frame images adjacent to each other.

Moreover, the animation processing unit 306 synthesizes the interpolation frame images and the background image with each other by using a publicly known image synthesis method in a similar way to the case of the foregoing reference frame images.

Next, together with the musical performance information 305b of the music to be automatically performed by the animation playing unit 306j, the CPU of the central control unit 301 transmits data of a preview animation composed of the reference frame images and the interpolation frame images, which are to be played at predetermined timing of the music concerned, to the user terminal 2 through the predetermined communication network N by the communication control unit 303 (Step S16). Here, the data of the preview animation composes an animation in which a plurality of the frame images made of a predetermined number of the reference frame images and a predetermined number of the interpolation frames and the background image desired by the user are synthesized with each other.

Next, the animation processing unit 306 returns the processing to Step S13, and determines whether or not the musical performance of the music is ended (Step S13).

The foregoing processing is repeatedly executed until it is determined that the musical performance of the music is ended in Step S13 (Step S13: YES).

Then, when it is determined that the musical performance of the music is ended (Step S13: YES), as shown in FIG. 5, the CPU of the central control unit 301 returns the processing to Step S4, and branches the processing in response to the contents of the instruction from the user terminal 2 (Step S4).

When the data of the preview animation transmitted from the server 3 is received by the communication control unit 303 of the user terminal 2, the CPU of the central control unit 201 controls the sound output unit 204 and the display unit 203 to play the preview animation (Step S17).

Specifically, based on the musical performance information 305b, the sound output unit 204 automatically performs the music and emits the sound from the speaker, and the display unit 203 displays the preview animation made of the reference frame images and the interpolation frame images on the display screen at the predetermined timing of the music concerned to be automatically performed.

Note that, in the animation creation processing described above, the preview animation is played; however, the playing of the preview animation is merely an example, and a playing target of the present invention is not limited to this. For example, such a configuration as follows may be adopted. The image data of the reference frame images and the interpolation frame images, which are sequentially created, and of the background image, and the musical performance information 305b, are integrated as one file, and are stored in the predetermined storage unit, and after the creation of all the data related to the animation is completed, the file concerned is transmitted from the server 3 to the user terminal 2, and is played in the user terminal 2 concerned.

### <Control Point Setting Processing>

A description is made bellow in detail of the control point setting processing by the animation processing unit 306 with reference to FIG. 6 to FIG. 14.

FIG. 6 is a flowchart showing an example of operations related to the control point setting processing in the animation creation processing.

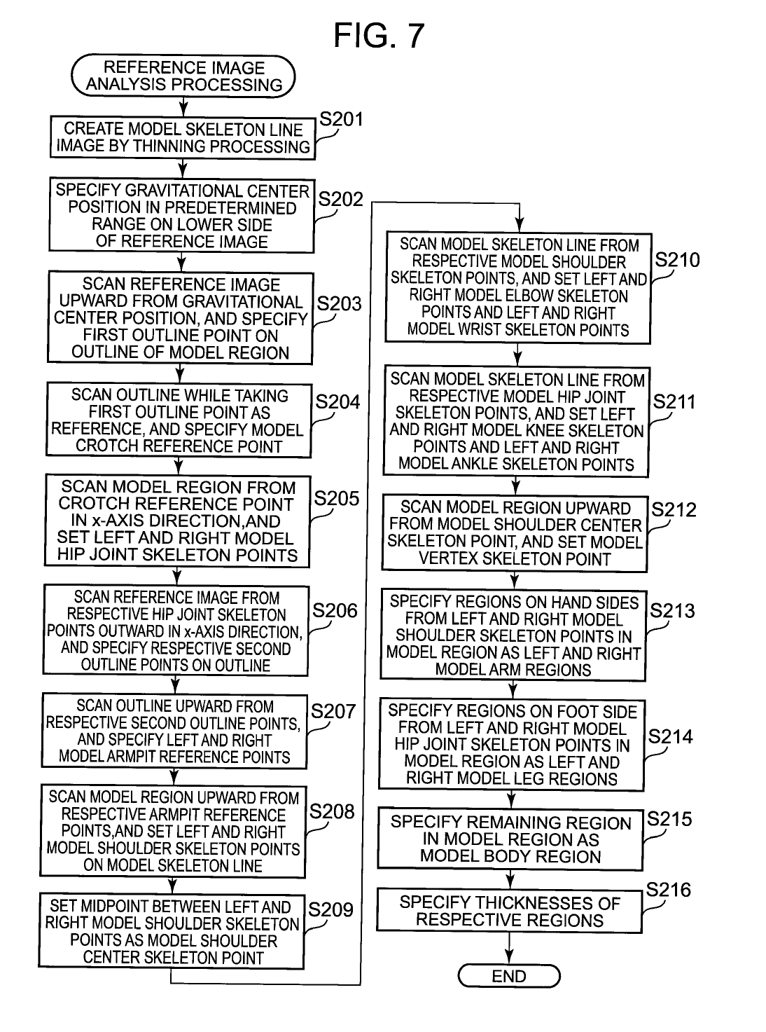

First, as shown in FIG. 6, the animation processing unit 306 performs reference image analysis processing (refer to FIG. 7) for analyzing the reference image P1 showing the position of the model region 1A of the moving subject model (Step S101). Note that the reference image analysis processing will be described later.

Next, the animation processing unit 306 performs subject image analysis processing for analyzing the images of the subject regions 2A of the subject clipped image and the mask image P2 (Step S102). Note that the subject image analysis processing will be described later.

Then, the animation processing unit 306 performs position specification processing (refer to FIG. 8) for specifying the positions of the respective motion reference points Q in the model region 1A of the moving subject model of the reference image P1 (Step S103). Note that the reference position specification processing will be described later.

Thereafter, the animation processing unit 306 performs control point position specification processing (refer to FIG. 9) for specifying the positions of the motion control points J corresponding to the respective motion reference points Q in the subject region 2A of the mask image P2 (Step S104). Note that the control point position specification processing will be described later.

Subsequently, in the subject regions 2A of the subject clipped image and the mask image P2, the animation processing unit 306 sets the motion control points J, which correspond to the motion reference points Q, at the respective positions specified by the control point position specification processing (Step S105), and ends the control point setting processing.

### <Reference Image Analysis Processing>

A description is made below in detail of the reference image analysis processing by the animation processing unit 306 with reference to FIG. 7 to FIG. 9.

FIG. 7 is a flowchart showing an example of operations related to the reference image analysis processing in the animation creation processing.

As shown in FIG. 7, the first skeleton information obtaining unit 306a of the animation processing unit 306 obtains the motion information 305a from the storage unit 305, and implements the thinning processing to create the line image composed of the pixels with a width of one pixel for the image data of the reference image P1 (refer to FIG. 8A) showing the position of the model region 1A of the moving subject model related to the motion information 305a concerned, thereby creating the model skeleton line image P1a (refer to FIG. 8B) (Step S201).

Next, the skeleton point setting unit 306d of the animation processing unit 306 specifies the gravitational center position in the predetermined range on the lower side of the reference image P1, for example, the range of approximately 4/6 to ⅚ among six portions obtained by equally dividing the reference image P1 in the y-axis direction (the up and down direction) (Step S202). Then, the skeleton point setting unit 306d scans the reference image P1 from the gravitational center position in the negative direction (the upper direction) of the y-axis, and specifies the intersection of the line thus scanned with the outline, which composes the model region 1A, as the first outline point (Step S203).

Next, the skeleton point setting unit 306d scans the outline from the specified first outline point in the respective directions (both of the upper direction and the lower direction) of the y-axis by a predetermined number of pixels, and based on the following Expression (1), searches the position “k” where the evaluation value “DD” becomes the maximum in the route portion thus scanned in the outline, and specifies the searched position as the model crotch reference point R1 (Step S204; refer to FIG. 9A).

Here, if the position “k” where the evaluation value “DD” becomes the maximum is defined as “maxK”, then the coordinate of the model crotch reference point R1 is defined by “tr (maxK)”. Note that, in the following Expression (1), “tr(n)·y” represents the y-coordinate at the position n in the route “tr”.

DD=−(yd_(k−2)+yd_(k−1))+(yd_(k+1)+yd_(k+2))

yd_(n)=tr(n+1)·y−tr(n)·y Expression (1);

Next, the skeleton point setting unit 306d scans the model region 1A of the reference image P1 from the model crotch reference point R1 in the respective directions (both of the leftward direction and the rightward direction) of the x-axis, and for each of the directions, specifies the intersection of the line thus scanned with a model skeleton line a1 of the model skeleton line image P1a. Then, the skeleton point setting unit 306d sets both of the specified intersections as the left and right model hip joint skeleton points S1 and S2 (Step S205; refer to FIG. 9B).

Subsequently, the skeleton point setting unit 306d scans the reference image P1 in the respective directions outside of the left and right hip joint skeleton points S1 and S2 taken as references along the x-axis direction from the respective hip joint skeleton points S1 and S2, and individually specifies the intersections of the lines thus scanned with the outline, which composes the model region 1A of the reference image P1, as the second outline points (Step S206; refer to FIG. 9B).

Then, the skeleton point setting unit 306d scans the outline from the respective specified second outline points in the negative direction (the upper direction) of the y-axis by a predetermined number of pixels, and based on the following Expressions (2) and (3), searches the position “k” where the evaluation value “DD” becomes the maximum in the route portion thus scanned in the outline, and specifies the left and right model armpit reference points R2 and R3 (Step S207; refer to FIG. 9A).

Here, if the position “k” where the evaluation value “DD” becomes the maximum is defined as “maxK”, then the coordinates of the left and right model armpit reference points R2 and R3 are defined by “tr (maxK)” Note that, in the following Expression (2), the coordinate of the position n in the left-side route “tr” can be obtained by (tr(n)·x, tr(n)·y). Moreover, in the following Expression (3), the coordinate of the position n in the right-side route “tr” can be obtained by (tr(n)·x, tr(n)·y).

DD=−(d_{—}tr(k−2)·y+d_{—}tr(k−1)·y)−(d_{—}tr(k+1)·x+d_{—}tr(k+2)·x)

d_{—}tr(n)=tr(n+1)−tr(n) Expression (2);

DD=−(d_{—}tr(k−2)·y+d_{—}tr(k−1)·y)+(d_{—}tr(k+1)·x+d_{—}tr(k+2)·x)

d_{—}tr(n)=tr(n+1)−tr(n) Expression (3);

Next, the skeleton point setting unit 306d scans the model region 1A of the reference image P1 individually from the left and right model armpit reference points R2 and R3 in the negative direction (the upper direction) of the y-axis, and specifies the respective intersections of the lines thus scanned with the model skeleton line a1 of the model skeleton image P1a. Then, the skeleton point setting unit 306d sets both of the specified intersections as the left and right model shoulder skeleton points S3 and S4 (Step S208; refer to FIG. 9B).

Then, the skeleton point setting unit 306d specifies the midpoint between the left and right model shoulder skeleton points S3 and S4 in the model region 1A of the reference image P1, and sets the specified midpoint as the model shoulder center skeleton point S5 (Step S209; refer to FIG. 9B).

Next, the skeleton point setting unit 306d sets the left and right model elbow skeleton points S6 and S8 and the left and right model wrist skeleton points S7 and S9 (Step S210; refer to FIG. 9B) in the model region 1A of the reference image P1 (Step S210; refer to FIG. 9B).

Specifically, the skeleton point setting unit 306d scans the model skeleton line a1 of the model skeleton line image P1a from the left model shoulder skeleton point S3 in the model region 1A of the reference image P1, and sets the left model elbow skeleton point S6 and the left model wrist skeleton point S7 at the positions between which a predetermined ratio is established while taking the distance to the tip end portion on the left hand side as a reference. In a similar way, for example, the skeleton point setting unit 306d scans the model skeleton line a1 of the model skeleton line image P1a from the right model shoulder skeleton point S4 in the model region 1A of the reference image P1, and sets the right model elbow skeleton point S8 and the right model wrist skeleton point S9 at the positions between which a predetermined ratio is established while taking the distance to the tip end portion on the right hand side as a reference.

Then, the skeleton point setting unit 306d sets the left and right model knee skeleton points S10 and S12 and the left and right model ankle skeleton points S11 and S13 in the model region 1A of the reference image P1 (Step S211; refer to FIG. 9B).

Specifically, the skeleton point setting unit 306d scans the model skeleton line a1 of the model skeleton line image P1a from the left model hip joint skeleton point S1 in the model region 1A of the reference image P1, and sets the left model knee skeleton point S10 and the left model ankle skeleton point S11 at the positions between which a predetermined ratio is established while taking the distance to the tip end portion on the left foot side as a reference. In a similar way, for example, the skeleton point setting unit 306d scans the model skeleton line a1 of the model skeleton line image P1a from the right model hip joint skeleton point S2 in the model region 1A of the reference image P1, and sets the right model knee skeleton point S12 and the right model ankle skeleton point S13 between which a predetermined ratio is established while taking the distance to the Lip end portion on the right foot side as a reference.

Next, the skeleton point setting unit 306d scans the model region 1A of the reference image P1 from the model shoulder center skeleton point S5 in the negative direction (the upper direct-ion) of the y-axis, and specifies the intersect ion of the line thus scanned with the outline composing the model region 1A. Then, the skeleton point setting unit 306d sets the specified intersection as the model vertex skeleton point S14 (Step S212; refer to FIG. 9B).

Then, in the model region 1A of the reference image P1, the region specifying unit 306e of the animation processing unit 306 specifies the regions on the hand sides from the left and right model shoulder skeleton points S3 and S4 as the left and right model arm regions B1 and B2 (Step S213; refer to FIG. 9C).

Specifically, the region specifying unit 306e scans the model region 1A from the left model shoulder skeleton point S3 in the respective directions (both of the upper direction and the lower direction) of the y-axis, and individually specifies the intersections of the lines thus scanned with the outline composing the model region 1A. Then, in the model region 1A, the region specifying unit 306e specifies the region, which is obtained by dividing the model region 1A by the segment connecting these two intersections to each other, and exists on the opposite side (the hand side) to the model shoulder center skeleton point S5, as the left model arm region B1 corresponding to the left arm of the human body. In a similar way, the region specifying unit 306e performs similar processing also for the right model arm region B2 corresponding to the right arm of the human body, and specifies the right model arm region B2.

Next, in the model region 1A of the reference image P1, the region specifying unit 306e of the animation processing unit 306 specifies the regions on the foot sides from the left and right model hip joint skeleton points S1 and S2 as the left and right model leg regions B3 and B4 (Step S214; refer to FIG. 9C).

Specifically, the region specifying unit 306e scans the model region 1A from the left model hip joint skeleton point S1 in the respective directions (both of the leftward direction and the rightward direction) of the x-axis, and individually specifies the intersections of the lines thus scanned with the outline composing the model region 1A. Then, in the model region 1A, the region specifying unit 306e specifies the region, which is obtained by dividing the model region 1A by the segment connecting these two intersections to each other, and exists on the opposite side (the foot side) to the model shoulder center skeleton point S5, as the left model leg region B3 corresponding to the left leg of the human body. In a similar way, the region specifying unit 306e performs similar processing also for the right model leg region B4 corresponding to the right leg of the human body, and specifies the right model leg region B4.

Thereafter, the region specifying unit 306e specifies the region, which remains as a result of that the left and right model arm regions B1 and B2 and the left and right model leg regions B3 and B4 are specified in the model region 1A, as the model body region B5 (Step S215; refer to FIG. 9C).

Next, the region specifying unit 306e specifies the thicknesses (the widths) of the left and right model arm regions B1 and B2, the left and right model leg regions B3 and B4 and the model body region B5 (Step S216; refer to FIG. 9C).

Specifically, the region specifying unit 306e specifies the respective intersections of the straight line, which passes through the left model elbow skeleton point S6 and is extended along the y-axis direction, with the outline, and specifies the distance between the intersections concerned as the thickness (the width) of the left model arm region B1. In a similar way, the region specifying unit 306e specifies the thickness of the right model arm region B2.

Moreover, the region specifying unit 306e specifies the respective intersections of the straight line, which passes through the left model knee skeleton point S10 and is extended along the x-axis direction, with the outline, and specifies the distance between the intersections concerned as the thickness of the left model leg region B3. In a similar way, the region specifying unit 306e specifies the thickness of the right model leg region B4.

Furthermore, the region specifying unit 306e specifies the distance between the left and right model shoulder skeleton points S3 and S4 as the thickness of the model body region B5.

In such a way, the reference image analysis processing is ended.

### <Subject Image Analysis Processing>

A description is made below in detail of the subject image analysis processing by the animation processing unit 306 with reference to FIG. 10.

FIG. 10A and FIG. 10B are views schematically showing an example of the image related to the subject image analysis processing in the animation creation processing.

The subject image analysis processing is substantially similar to the reference image analysis processing described above except that the subject clipped image and the mask image P2 are defined as the processing targets, and a detailed description thereof is omitted.

That is to say, in the subject image analysis processing, for the mask image P2 (refer to FIG. 10A), the skeleton point setting unit 306d performs similar processing to that in the specifying method of the model crotch reference point R1 and the left and right model armpit reference points R2 and R3, and specifies the subject crotch reference point H1 and the left and right subject armpit reference points H2 and H3 in the subject region 2A of the mask image P2 (refer to FIG. 10B).

Moreover, for the mask image P2, the skeleton point setting unit 306d performs similar processing to that in the setting method of the left and right model hip joint skeleton points S1 and S2, the left and right model shoulder skeleton points S3 and S4, the model shoulder center skeleton point S5, the left and right model elbow skeleton points S6 and S8, the left and right model wrist skeleton points S7 and S9, the left and right model knee skeleton points S10 and S12, the left and right model ankle skeleton points S11 and S13 and the model vertex skeleton point S14. In such a way, in the subject region 2A of the mask image P2 concerned, the skeleton point setting unit 306d sets the left and right subject hip joint skeleton points I1 and I2, the left and right subject shoulder skeleton points I3 and I4, the subject shoulder center skeleton point I5, the left and right subject elbow skeleton points I6 and I8, the left and right subject wrist skeleton points I7 and I9, the left and right subject knee skeleton points I10 and I12, the left and right subject ankle skeleton points I11 and I13 and the subject vertex skeleton point I14.

Furthermore, the region specifying unit 306e performs similar processing to the foregoing processing for the model region 1A of the reference image P1, and specifies the left and right subject arm regions D1 and D2, the left and right subject leg regions D3 and D4 and the subject body region 5 and the thicknesses of these respective regions in the subject region 2A of the mask image P2 (refer to FIG. 10B).

### <Reference Point Position Specification Processing>

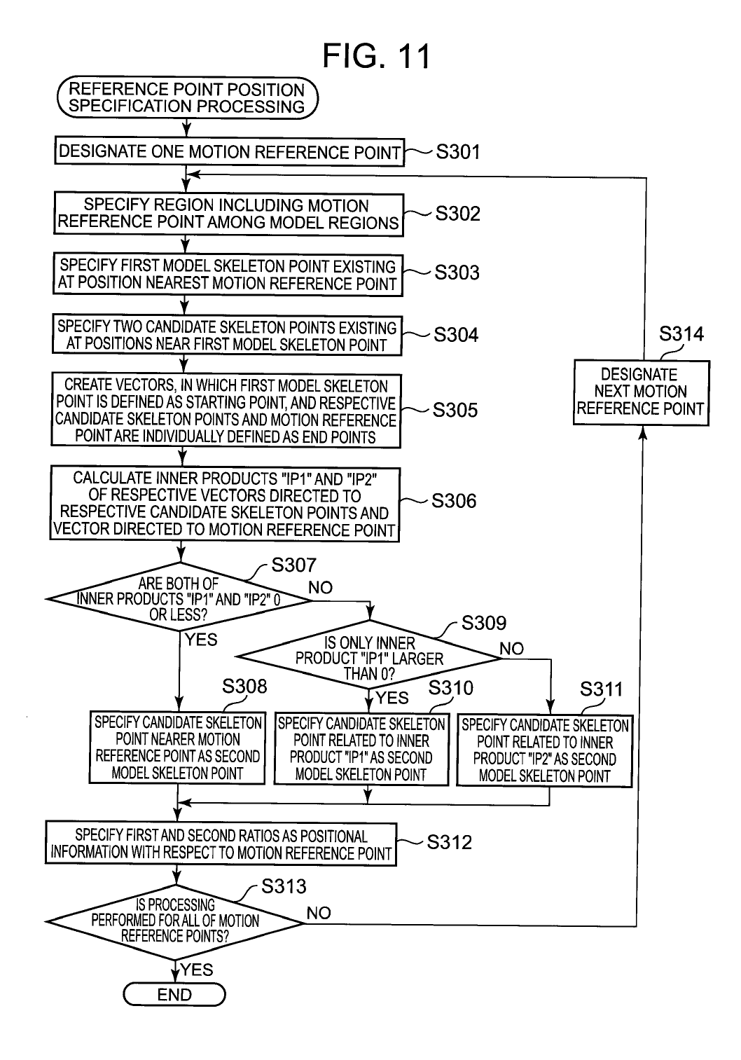

A description is made below in detail of the reference point position specification processing by the animation processing unit 306 with reference to FIG. 11 and FIG. 12.

FIG. 11 is a flowchart showing an example of operations related to the reference point position specification processing in the animation creation processing.

As shown in FIG. 11, among the plurality of motion reference points Q . . . , the reference point position specifying unit 306f of the animation processing unit 306 designates any one motion reference point Q (for example, the left wrist motion reference point Q1) (Step S301), and thereafter, for the model region 1A, specifies the region B (for example, the left model arm region B1 or the like) of the spot, which includes the motion reference point Q serving as the processing target, among the left and right model arm regions B1 and B2, the left and right model leg regions B3 and B4 and the model body region B5, which are specified by the region specifying unit 306e (Step S302).

Note that the specification of the region B in Step S302 may be performed after the specification of the first and second model skeleton points “KP1” and “KP2”. In this case, the region B of the spot including the first and second model skeleton points “KP1” and “KP2” (that is, the region B of the spot including the motion reference point Q serving as the processing target, and including the first and second model skeleton points “KP1” and “KP2”) may be specified.

Next, among the plurality of model skeleton points S . . . set by the skeleton point setting unit 306d, the reference point position specifying unit 306f specifies the first model skeleton point “KP1” that exists at the position nearest the motion reference point Q as the processing target (Step S303). Then, the reference point position specifying unit 306f specifies two model skeleton points S and S, which exist at the positions near the specified first model skeleton point, as the candidate skeleton points “KP2_1” and “KP2_2” (Step S304).

Subsequently, the reference point position specifying unit 306f creates the respective vectors “KP2_1-KP1”, “IKP2_2-KP1” and “Q-KP1”, in which the first model skeleton point is defined as the starting point, and the candidate skeleton points “KP2_1” and “KP2_2” and the motion reference point Q as the processing target are defined as the end points, respectively (Step S305). Then, the reference point position specifying unit 306f individually calculates the inner products “IP1” and “IP2” of the respective vectors directed to the respective candidate skeleton points “KP2_1” and “KP2_2” and the vector directed to the motion reference point Q as the processing target in accordance with a predetermined arithmetic expression (Step S306).

Next, the reference point position specifying unit 306f determines whether or not both of the two inner products “IP1” and “IP2” are “0” or less (Step S307).

Here, if it is determined that both of the two inner products “IP1” and “IP2” are “0” or less (Step S307: YES), then the reference point position specifying unit 306f specifies the skeleton point, which is nearer the motion reference point Q between the two candidate skeleton points “KP2_1” and “KP2_2”, as the second model skeleton point “KP2” (Step S308).

Meanwhile, if it is determined in Step S307 that both of the two inner products “IP1” and “IP2” are not “0” or less (Step S307: NO), then the reference point position specifying unit 306f determines whether or not only the inner product “IP1” is larger than “0” (Step S309).

If it is determined in Step S309 that only the inner product “IP1” is larger than “0” (Step S309: YES), then the reference point position specifying unit 306f specifies the candidate skeleton point “KP2_1”, which is related to the inner product “IP1”, as the second model skeleton point “KP2” (Step S310).

Meanwhile, if it is determined in Step S309 that only the inner product “IP1” is not larger than “0” (Step S309: NO), then the reference point position specifying unit 306f specifies the candidate skeleton point “KP2_2”, which is related to the inner product “IP2”, as the second model skeleton point “KP2” (Step S311).

Thereafter, the reference point position specifying unit 306f specifies the first ratio and the second ratio as the positional information with respect to the motion reference point Q (Step S312; refer to FIG. 12).

Specifically, the reference point position specifying unit 306f specifies the position of the intersection “CP1” of the first segment “L1”, which connects the first model skeleton point “KP1” and the second model skeleton point “KP2” to each other, and of the straight line, which is perpendicular to the first segment “L1” concerned and passes through the motion reference point Q. Then, the reference point position specifying unit 306f specifies the length of the first segment “L1” as “1”, and specifies, as the first ratio, the ratio of distances individually from the first model skeleton point “KP1” and the second model skeleton point “KP2” to the intersection “CP1”.

Moreover, the reference point position specifying unit 306f specifies the second segment “L2”, which has a half-length of the length of the region specified by the region specifying unit 306e, and is the segment, which is perpendicular to the segment “L1”, and is extended to the motion reference point Q side from the first model skeleton point “KP1”. Subsequently, the reference point position specifying unit 306f specifies the position of the intersection “CP2” of the second segment “L2” and the straight line, which is perpendicular to the second segment “L2” concerned, and passes through the motion reference point Q. Then, the reference point position specifying unit 306f defines the length of the second segment “L2” as “1”, and specifies, as the second ratio, the ratio of the distances individually from the first model skeleton point “KP1” and the end portion “L2a” of the second segment “L2” to the intersection “CP2”.

Next, the reference point position specifying unit 306f determines whether or not to have performed the processing for specifying the positional information for all of the motion reference points Q (Step S313).

Here, if it is determined that the positional information is not specified for all of the motion reference points Q. (Step S313: NO), then among the plurality of motion reference points Q . . . , the reference point position specifying unit 306f designates the motion reference point Q (for example, the right wrist motion reference point Q2 or the like), which is not designated yet, as the next processing target (Step S314), and thereafter, shifts the processing to Step S302.

Thereafter, the animation processing unit 306 sequentially and repeatedly executes the processing on and after Step S302 until determining in Step S313 that the positional information is specified for all of the motion reference points Q (Step S313: YES). In such a way, the positional information (the first ratio and the second ratio) is specified for each of the plurality of motion reference points Q . . . .

Then, if it is determined in Step S313 that the positional information is specified for all of the motion reference points Q (Step S313: YES), then the animation processing unit 306 ends the reference point position specification processing concerned.

### <Control Point Position Specification Processing>

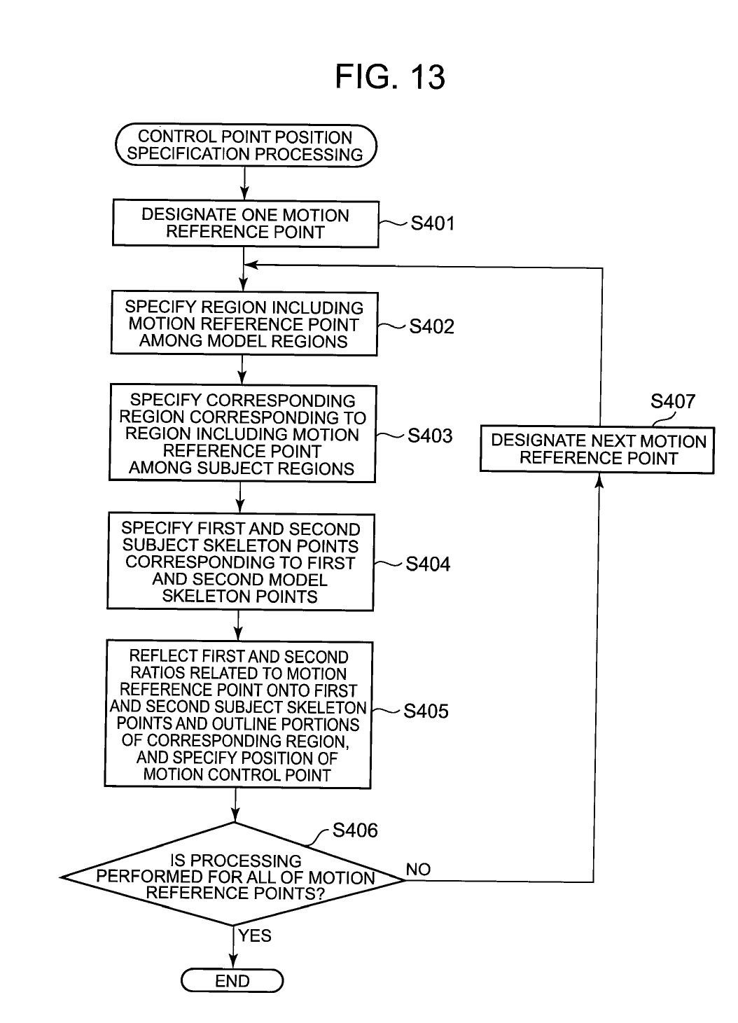

A description is made below in detail of the control point position specification processing by the animation processing unit 306 with reference to FIG. 13 and FIG. 14.

FIG. 13 is a flowchart showing an example of operations related to the control point position specification processing in the animation creation processing.

As shown in FIG. 13, the control point setting unit 306g of the animation processing unit 306 designates any one motion reference point Q (for example, the left wrist motion reference point Q1) among the plurality of motion reference points Q . . . (Step S401), and thereafter, for the model region 1A, specifies the region B (for example, the left model arm region B1 or the like) of the spot, which includes the motion reference point Q serving as the processing target, among the left and right model arm regions B1 and B2, the left and right model leg regions B3 and B4 and the model body region B5, which are specified by the region specifying unit 306e (Step S402).

Next, for the subject region 2A, the control point setting unit 306g specifies the corresponding region D (for example, the left subject arm region D1 or the like) corresponding to the region B (for example, the left model arm region B1 or the like) of the spot, which includes the motion reference point Q serving as the processing target, among the left and right subject arm regions D1 and D2, the left and right subject leg regions D3 and D4, and the subject body region D5, which are specified by the region specifying unit 306e (Step S403).

Next, among the plurality of subject skeleton points I . . . set in the subject region 2A by the skeleton point setting unit 306d, the control point setting unit 306g specifies two subject skeleton points (for example, the first and second subject skeleton points) I and I corresponding to the first and second model skeleton points “KP1” and “KP2” specified by the reference point position specifying unit 306f (Step S404). Subsequently, the control point setting unit 306g reflects the relative positional relationships of the two adjacent model skeleton points S and S with respect to the motion reference point Q, and the relative positional relationships (for example, the first ratio and the second ratio) of the outline portions of the region B of the spot including the two model skeleton points S and S concerned with respect thereto onto the two subject skeleton points I and I specified in the subject region 2A and onto the outline portions of the corresponding region D including the two subject skeleton points I and I, and in the corresponding region D concerned, specifies the position of the motion control point J (for example, the left wrist motion control point J1 or the like) (Step S405; refer to FIG. 14).

Next, the control point setting unit 306g determines whether or not to have performed the processing for specifying the positions of the motion control points J for all of the motion reference points Q (Step S406).

Here, if it is determined that the positions of all of the motion control points J are not specified (Step S406; NO), then among the plurality of motion reference points Q . . . , the control point setting unit 306g designates the motion reference point Q (for example, the right wrist motion reference point Q2 or the like), which is not designated yet, as the next processing target (Step S407), and thereafter, shifts the processing to Step S402.

Thereafter, the animation processing unit 306 sequentially and repeatedly executes the processing on and after Step S402 until determining in Step S406 that the positions of all of the motion control points J are specified (Step S406: YES). In such a way, for each of the plurality of motion reference points Q . . . , the position of the motion control point J corresponding thereto is specified.

Then, if it is determined in Step S406 that the positions of all of the motion control points J are specified (Step S406; YES), then the animation processing unit 306 ends the control point position specification processing concerned.

As described above, in accordance with the animation creation system 100 of this embodiment, based on the subject skeleton information related to the skeleton of the subject of the subject clipped image and on the positional information related to the respective positions of the plurality of motion reference points Q . . . in the model region 1A of the reference image P1, which includes the moving subject model, the plurality of motion control points J, which are related to the control for the motions of the subject region 2A, are set at the respective positions individually corresponding to the plurality of motion reference points Q . . . in the subject region 2A concerned. Accordingly, the plurality of motion control point J . . . can be automatically set at the appropriate positions in the subject region 2A in consideration of the positions of the respective motion reference points Q in the model region 1A and the skeleton of the subject of the subject clipped image. In such a way, the setting of the motion control points J can be performed simply and appropriately. As a result, the creation of the animation composed of the plurality of frame images which express the motions desired by the user can be performed as appropriate.

Moreover, there is specified the positional information including the information related to the relative positional relationships of the plurality of model skeleton points S . . . , which are associated with the skeleton of the moving subject model set in the model region 1A of the reference image P1, with respect to the plurality of respective motion reference points Q . . . , and in particular, the positional information including the information related to the relative positional relationships of the two adjacent model skeleton points S and S, which are set so as to sandwich each of the motion reference points Q in a predetermined direction, with respect to each of the motion reference points Q. Accordingly, the plurality of motion control point J . . . can be set at the appropriate positions in the subject region 2A in consideration of the relative positional relationships of the plurality of model skeleton points S . . . with respect to the respective motion reference points Q.

Moreover, the positional information including the information related to the relative positional relationships of the outline potions of the spot, which includes the two model skeleton points S and S in the model region 1A, with respect to each of the motion reference points Q is specified. Accordingly, the plurality of motion control point J . . . can be set at the appropriate positions in the subject region 2A in consideration of the relative positional relationships of the outline portions.

Moreover, based on the model skeleton reference points R specified at the portions where the plurality of spots composing the human body are connected to each other, the portions being of the outline portion of the model region 1A, the plurality of model skeleton points S . . . are set in the model region 1A of the reference image P1. Accordingly, the plurality of model skeleton points S . . . can be set at the appropriate positions in the model region 1A in consideration of the plurality of spots composing the human body and the connectedness between the spots concerned.

Moreover, based on the information related to the relative positional relationships of the plurality of model skeleton points S . . . with respect to the plurality of respective motion reference points Q . . . and on the subject skeleton points I, which are set in the subject region of the subject clipped image and are associated with the skeleton of the subject, the plurality of motion control points J . . . are set in the subject region 2A concerned. Accordingly, the plurality of motion control points J . . . can be set at the appropriate positions in the subject region 2A in consideration of the relative positional relationships of the plurality of model skeleton points S . . . with respect to the respective motion reference points Q and the arrangement of the plurality of subject skeleton points I . . . set in the subject region 2A.

In particular, based on the subject skeleton reference points H specified in the portions where the plurality of spots composing the human body are connected to each other, the portions being the outline portions of the subject region 2A, the plurality of subject skeleton points I . . . are set in the subject region 2A of the mask image P2. Accordingly, the plurality of subject skeleton points I . . . can be set at the appropriate positions in the subject region 2A in consideration of the plurality of spots composing the human body and the connectedness between the spots concerned.

Moreover, the two subject skeleton points I and I corresponding to the two adjacent model skeleton points S and S set so as to sandwich each of the plurality of motion reference points Q . . . in the model region 1A are specified, and in the subject region 2A, each of the motion control points J is set at the position having, with respect to the two subject skeleton points I and I, the relative positional relationships corresponding to the relative positional relationships of the two model skeleton points S and S with respect to each of the motion reference points Q. Accordingly, the relative positional relationships of the two model skeleton points S and S with respect to each of the motion reference points Q can be reflected onto the two subject skeleton points I and I in the subject region 2A, and each of the motion control points J can be set with respect to the two subject skeleton points I and I in the subject region 2A so as to correspond to the position of each of the motion reference points Q with respect to the two adjacent model skeleton points S and S in the model region 1A.

Furthermore, in the subject region 2A, the corresponding region D corresponding to the region B of the spot including the two model skeleton points S and S is specified, and in the corresponding region D, each of the motion control points J is set at the position that has, with respect to the outline portions of the corresponding region D, the relative positional relationships corresponding to the relative positional relationships of the outline portions of the spot including the two model skeleton points S and S with respect to each of the motion reference points Q. Accordingly, the relative positional relationships of the outline portions of the spot including the two model skeleton points S and S with respect to each of the motion reference points Q can be reflected onto the outline portions of the corresponding region D, and each of the motion control points J can be set with respect to the outline portions of the spot including the two subject skeleton points I and I in the corresponding region D so as to correspond to the position of each of the motion reference points Q with respect to the outline portions of the spot including the two adjacent model skeleton points S and S in the model region 1A.

Moreover, the plurality of motion control points J . . . are moved based on the motions of the plurality of motion reference points Q . . . of the motion information 305a, and the plurality of frame images, in each of which the subject region of the subject clipped image is deformed, are created in accordance with the motion control points J concerned. Accordingly, the deformation of the subject clipped image can be appropriately performed in accordance with the motions of the plurality of motion control points J . . . .

Note that the present invention is not limited to the foregoing embodiment, and may be improved and changed in design in various ways within the scope without departing from the spirit of the present invention.

For example, in the foregoing embodiment, based on the predetermined operation for the user terminal 2 by the user, the animation is created by the server (the control point setting apparatus) 3 that functions as a Web server; however, this is merely an example, and the configuration of the control point setting apparatus is changeable appropriately and arbitrarily. That is to say, a configuration is adopted, in which the function of the animation processing unit 306 related to the creation of the back surface image is realized by software, and then the software concerned is installed in the user terminal 2. In such a way, the animation creation processing may be performed only by the user terminal 2 itself without requiring the communication network N.

Moreover, in the foregoing embodiment, the subject clipped image is treated as the processing target; however, this is merely an example, and the processing target of the present invention is not limited to this, and is changeable appropriately and arbitrarily. For example, an image with only the subject region may be used from the beginning.

Moreover, the animation creation processing of the foregoing embodiment may be configured so as to be capable of adjusting the synthetic positions and sizes of the subject images. That is to say, in the case of having determined that an adjustment instruction for the synthetic positions and sizes of the subject images is inputted based on a predetermined operation for the operation input unit 202 by the user, the central control unit 201 of the user terminal 2 transmits a signal, which corresponds to the adjustment instruction concerned, to the server 3 through the predetermined communication network N by the communication control unit 206. Then, based on the adjustment instruction inputted through the communication control unit, the animation processing unit 306 of the server 3 may set the synthetic positions of the subject images at desired synthetic positions, or may set the sizes of the subject images at desired sizes.

Furthermore, in the foregoing embodiment, the personal computer is illustrated as the user terminal 2; however, this is merely an example, and the user terminal of the present invention is not limited to this, and is changeable appropriately and arbitrarily. For example, a cellular phone and the like may be applied as the user terminal.

Note that control information for prohibiting a predetermined modification by the user may be embedded in the data of the subject clipped image and the animation.

In addition, in the foregoing embodiment, a configuration is adopted, in which the functions as the specifying unit, the obtaining unit and the control point setting unit are realized in such a manner that the reference point position specifying unit 306f, the image obtaining unit 306b and the control point setting unit 306g are driven under the control of the central control unit 301. However, the configuration of the present invention is not limited to this, and a configuration that is realized in such a manner that a predetermined program and the like are executed by the CPU of the central control unit 301 may be adopted.

That is to say, in a program memory (not shown) that stores programs, a program is stored in advance, which includes a specification processing routine, an obtaining processing routine, and a control point setting processing routine. Then, by the specification processing routine, the CPU of the central processing unit 301 may be allowed to function as the specifying unit that specifies the position information, which is related to the respective positions of the plurality of motion reference points Q in the model region 1A of the moving subject model, based on the model skeleton information related to the skeleton of the moving subject model. Moreover, by the obtaining processing routine, the CPU of the central processing unit 301 may be allowed to function as the obtaining unit that obtains the subject image including the subject region. Furthermore, by the control point setting processing routine, the CPU of the central control unit 301 may be allowed to function as the control point setting unit that sets the plurality of motion control points J, which are related to the motion control for the subject region, at the respective positions corresponding to the plurality of respective motion reference points Q . . . in the subject region based on the subject skeleton information related to the skeleton of the subject in the subject image obtained by the obtaining unit and on the positional information specified by the specifying unit.

Moreover, as a computer-readable medium that stores therein the program for executing the respective pieces of the foregoing processing, it is also possible to apply a nonvolatile memory such as a flash memory and a portable recording medium such as a CD-ROM as well as the ROM, the hard disc and the like. Moreover, as a medium that provides the data of the program through the predetermined communication network, a carrier wave is also applied.

What is claimed is:

1. A control point setting method that uses a control point setting apparatus including a storage unit that stores motion information of a plurality of motion reference points set in a region of a moving subject model included in a reference image, the control point setting method comprising:
specifying positional information related to respective positions of the plurality of motion reference points in the region of the moving subject model based on model skeleton information related to a skeleton of the moving subject model;
obtaining a subject image including a subject region; and
setting a plurality of motion control points related to motion control for the subject region at respective positions individually corresponding to the plurality of motion reference points in the subject region based on subject skeleton information related to the skeleton of the subject of the subject image obtained in the obtaining and on the positional information specified in the specifying.

2. The control point setting method according to claim 1, further comprising:
setting a plurality of model skeleton points associated with the skeleton of the moving subject model in the region of the moving subject model based on the model skeleton information,
wherein the positional information includes information related to relative positional relationships of the plurality of model skeleton points with respect to the plurality of respective motion reference points, the plurality of model skeleton points being set in the skeleton point setting.

3. The control point setting method according to claim 2,
wherein the specifying further specifies, among the plurality of model skeleton points, two model skeleton points adjacent to each other, the two model skeleton points being set to sandwich each of the plurality of motion reference points in a predetermined direction, and specifies the positional information including information related to relative positional relationships of the two model skeleton points with respect to each of the motion reference points.

4. The control point setting method according to claim 3,
wherein the specifying further specifies outline portions of a spot including the two model skeleton points in the region of the moving subject model, and specifies the positional information including information related to relative positional relationships of the outline portions with respect to each of the motion reference points.

5. The control point setting method according to claim 2,
wherein the reference image is an image showing a state where a person as the moving subject model is viewed from a predetermined direction, and
the skeleton point setting specifies skeleton reference points at portions where a plurality of spots composing a human body are connected to each other, the portions being an outline portion of the region of the moving subject model, and sets the plurality of model skeleton points in the region of the moving subject model based on the skeleton reference points.

6. The control point setting method according to claim 2,
wherein the skeleton point setting further sets a plurality of subject skeleton points associated with the skeleton of the subject in the subject region based on the subject skeleton information, and
the control point setting sets the plurality of motion control points in the subject region based on information related to relative positional relationships of the plurality of model skeleton points with respect to the plurality of model reference points, the plurality of model skeleton points being specified in the specifying, and on the plurality of subject skeleton points set in the subject region in the skeleton point setting.

7. The control point setting method according to claim 6,
wherein the subject image is an image showing a state where a person as the subject is viewed from a predetermined direction, and
the skeleton point setting specifies skeleton reference points at portions where a plurality of spots composing a human body are connected to each other, the portions being an outline portion of the subject region, and sets the plurality of subject skeleton points in the subject region based on the skeleton reference points.

8. The control point setting method according to claim 6,
wherein the control point setting includes specifying two subject skeleton points corresponding to two model skeleton points adjacent to each other, the two model skeleton points being set to sandwich each of the plurality of motion reference points in a predetermined direction, the plurality of motion reference points being specified in the specifying, among the plurality of subject skeleton points set in the subject region in the skeleton point setting, and
in the subject region, the control point setting sets each of the motion control points at a position having, with respect to the two subject skeleton points, relative positional relationships corresponding to relative positional relationships of the two model skeleton points with respect to each of the motion reference points.

9. The control point setting method according to claim 8,
wherein the control point setting includes specifying a corresponding region corresponding to a region of a spot including the two model skeleton points adjacent to each other in the subject region, and
in the corresponding region, the control point setting sets each of the motion control points at a position having, with respect to outline portions of the corresponding region, relative positional relationships corresponding to relative positional relationships of outline portions of the spot including the two model skeleton points with respect to each of the motion reference points.

10. The control point setting method according to claim 1, further comprising:
moving the plurality of motion control points based on motions of the plurality of motion reference points of the motion information, and creating a plurality of frame images in which the subject region of the subject image is deformed in accordance with motions of the motion control points.

11. The control point setting method according to claim 1,
wherein the obtaining obtains an image, in which the subject region including the subject is clipped from an image where a background and the subject exist, as the subject image.

12. A control point setting apparatus including a storage unit that stores motion information of a plurality of motion reference points set in a region of a moving subject model included in a reference image, the control point setting apparatus comprising:
a specifying unit which specifies positional information related to respective positions of the plurality of motion reference points in the region of the moving subject model based on model skeleton information related to a skeleton of the moving subject model;
an obtaining unit which obtains a subject image including a subject region; and
a control point setting unit which sets a plurality of motion control points related to motion control for the subject region at respective positions individually corresponding to the plurality of motion reference points in the subject region based on subject skeleton information related to the skeleton of the subject of the subject image obtained in the obtaining unit and on the positional information specified in the specifying unit.

13. A recording medium recording a program which makes a computer of a control point setting apparatus including a storage unit that stores motion information of a plurality of motion reference points set in a region of a moving subject model included in a reference image, realize functions of:
a specifying function of specifying positional information related to respective positions of the plurality of motion reference points in the region of the moving subject model based on model skeleton information related to a skeleton of the moving subject model;
an obtaining function of obtaining a subject image including a subject region; and
a control point setting function of setting a plurality of motion control points related to motion control for the subject region at respective positions individually corresponding to the plurality of motion reference points in the subject region based on subject skeleton information related to the skeleton of the subject of the subject image obtained in the obtaining function and on the positional information specified in the specifying function.
